(19) United States
(12) Patent Application Publication
(10) Pub. No.: US 2015/0199980 A1
(43) Pub. Date: Jul. 16, 2015

(54) TAPE APPARATUS AND WRITE PROCESSING METHOD

(71) Applicant: FUJITSU LIMITED, Kawasaki-shi (JP)

(72) Inventor: Shigeharu AOKI, Edogawa (JP)

(73) Assignee: FUJITSU LIMITED, Kawasaki-shi (JP)

(21) Appl. No.: 14/573,024

(22) Filed: Dec. 17, 2014

(30) Foreign Application Priority Data
Jan. 15, 2014 (JP) 2014-005351

(51) Int. Cl. G11B 5/008

(52) U.S. Cl. CPC G11B 5/00817

(57) ABSTRACT

A tape apparatus includes a first write unit and a processor. The first write unit writes information into one track of a plurality of tracks included in a first tape medium.

The processor executes a process including performing control to make the first drive unit write write-target information into a first track, and performing control to make the first write unit write control information that indicates a terminal end of a track when a length from a position of the first write unit to a start position of the first track is equal to or greater than a prescribed threshold, and to move the first write unit to a second track.

### CROSS-REFERENCE TO RELATED APPLICATIONS

This application is based upon and claims the benefit of priority of the prior Japanese Patent Application No. 2014-005351, filed on Jan. 15, 2014, the entire contents of which are incorporated herein by reference.

### FIELD

The present invention relates to a control method of a tape apparatus.

### BACKGROUND

When making a backup in a tape cartridge for data in a mainframe, data of the same contents may be recorded in two tape cartridges, namely a main cartridge and a sub cartridge. In that case, two jobs are executed by two drives corresponding to the respective main and sub cartridges, to store data. FIG. 1 illustrates an example of recording of data into two tape cartridges. As illustrated in FIG. 1, a mainframe 1 is connected to a tape apparatus A (2a) and a tape apparatus B (2b). The tape apparatus A (2a) includes a main drive (4a) that performs reading and writing of data from and into a tape cartridge A inserted into the tape apparatus A (2a) and a control unit 3a that controls the main drive. The tape apparatus B includes a sub drive (4b) that performs reading and writing from and into a tape cartridge B inserted into the tape apparatus B and a control unit 3b that controls the sub drive. When the mainframe writes data into the two tape cartridges A and B, two jobs 5a and 5b to make a request to each of the control unit 3a and the control unit 3b for writing are executed.

There is a magnetic recording and playback apparatus that is capable of accessing a desired file in a short time when loading a tape. This magnetic recording and playback apparatus draws magnetic tape into a tape cassette in an unloading area adjacent to an approximately middle point between the recording terminal end of user data and the recording starting end of the magnetic tape.

Also, for example, Japanese Laid-open Patent Publication No. 2001-256695 is known.

### SUMMARY

According to an aspect of the embodiment, a tape apparatus includes a first write unit and a processor. The first write unit writes information into one track of a plurality of tracks included in a first tape medium. The processor executes a process including performing control to make the first drive unit write write-target information into a first track, and performing control to make the first write unit write control information that indicates a terminal end of a track when a length from a position of the first write unit to a start position of the first track is equal to or greater than a prescribed threshold, and to move the first write unit to a second track.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of recording of data into two tape cartridges;

FIG. 2 illustrates an example of the data structure of data stored in a tape cartridge;

FIG. 3 illustrates an example of the tape layout;

FIG. 4 illustrates an example of a search with the number of the tape mark being specified, in a layout in which the lap is turned back at the terminal end of the tape;

FIG. 5 illustrates an example of a search with the file name of the search target being specified, in a layout in which the lap is turned back at the terminal end of the tape;

FIG. 6 is a functional block diagram that illustrates the configuration of an embodiment of a tape apparatus;

FIG. 7 illustrates an example of the configuration of an information processing system according to the present embodiment;

FIG. 8 is a diagram illustrating an example of volume information;

FIG. 9 illustrates an example of the tape layout of a sub cartridge according to the present embodiment;

FIG. 10 is a diagram for illustrating the data structure of a control mark;

FIG. 11 is a diagram for explaining the writing of data into a sub cartridge in the present embodiment;

FIG. 12 illustrates a search for a file in a sub cartridge using a tape mark according to the present embodiment;

FIG. 13 illustrates a search for a file in a sub cartridge using the file name;

FIG. 14 illustrates the way in which a search for an overwrite-target file using the file name is performed and then overwriting is performed;

FIG. 15 illustrates the way in which a search for an overwrite-target file using a tape mark is performed and then overwriting of the file is performed;

FIG. 16 illustrates the way in which write-target data is written into a main cartridge;

FIGS. 17A and 17B illustrate the way in which EOT is detected during writing into a sub cartridge, and writing of write-target data is performed again after changing the turning-back position;

FIG. 18 is a flowchart illustrating the overall operation flow of a control unit;

FIG. 19 is a flowchart illustrating the operation flow of a host command receiving process;

FIG. 20 is a flowchart illustrating the operation of a monitoring process for the status of each drive;

FIG. 21 is the first half of a flowchart illustrating the processing content of a write process that writes a file into a main cartridge;

FIG. 22 the second half of a flowchart illustrating the processing content of a write process that writes a file into a main cartridge;

FIG. 23 is a flowchart illustrating the processing content of a write process that writes into a sub cartridge;

FIG. 24 is a flowchart illustrating the operation flow of a control mark write process;

FIG. 25 is a flowchart illustrating the operation flow of a search for a file in a sub drive with the tape mark number being specified;

FIG. 26 is a flowchart illustrating the operation flow of a search for a file in a sub drive with the file name being specified;

FIG. 27 is a flowchart illustrating the operation flow at the time of a tape cartridge ejection process; and

FIG. 28 illustrates an example of the hardware configuration of a tape apparatus.

### DESCRIPTION OF EMBODIMENTS

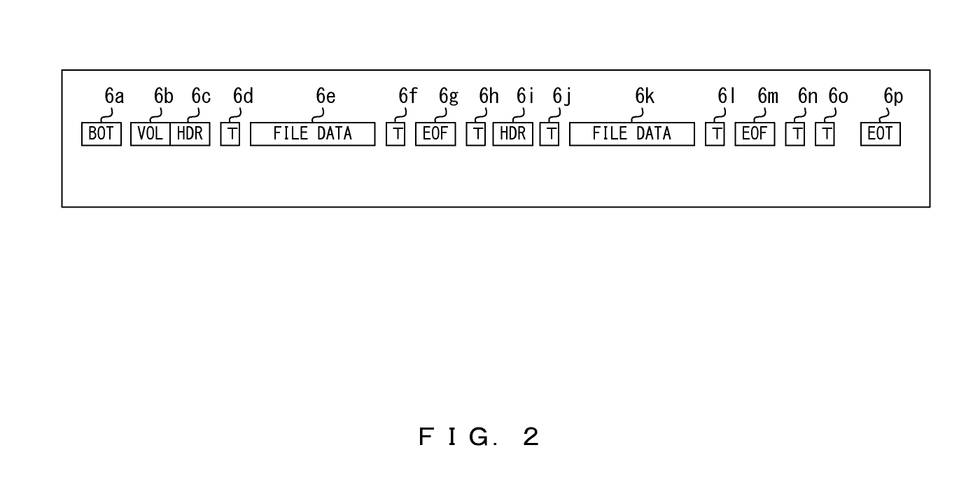

First, the data structure of data stored in a tape cartridge is explained. FIG. 2 is a diagram illustrating an example of the data structure of data stored in a tape cartridge. As illustrated in FIG. 2, data stored in the tape cartridge includes the respective areas of BOT (Beginning Of Tape) 6a, VOL (Volume) 6b, HDR (header) 6c and 6i, file data 6e and 6k, and EOF (End Of File) 6g and 6m. Data stored in the tape cartridge further includes the respective areas of T (Tape Mark) 6d, 6f, 6h, 6j, 61, 6n, and 6o, and EOT (End Of Tape) 6p.

Here, BOT (6a) is a mark that indicates the starting end of the data writing area of the tape cartridge, and EOT (6p) is a mark that indicates the terminal end of the data writing area of the tape cartridge. Data is stored in the area between BOT (6a) and the EOT (6p).

VOL (6b) is a volume area, in which an identification label of a user and a volume recorded in the tape cartridge are stored. The size of this VOL (6b) is 80 bytes.

HDR (6c, 6i) is a header area, in which a label to identify file data is recorded. The size of HDR (6c, 6i) is 80 bytes.

The file data (6e, 6k) is the main body of the data that the user wishes to store.

EOF (6g, 6m) indicates the end of the file data. The size of EOF (6g, 6m) is 80 bytes.

T (6d, 6f, 6h, 6j, 6l, 6n, 6o) is a special code or a code string recorded to control data reading and writing on the cartridge medium. T (6d, 6f, 6h, 6j, 6l, 6n, 6o) indicates a boundary between the file data and labels such as HDR and EOF, or a boundary between label groups.

In the cartridge medium, HDR, T, file data, T, EOF,

T are assumed to be a unit of data writing, and in the explanation below, these are collectively and simply referred to as a file. Two successively-recorded Ts indicate the end of writing into the tape cartridge. That is, in the example illustrated in FIG. 2, T (6o) written after T (6n) indicates the end of writing.

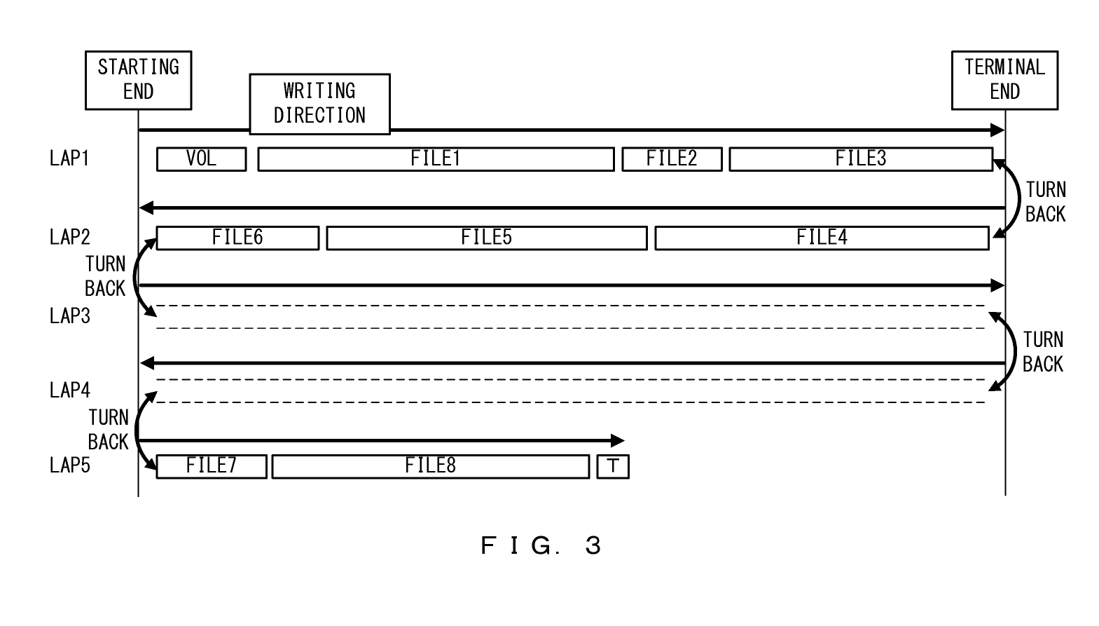

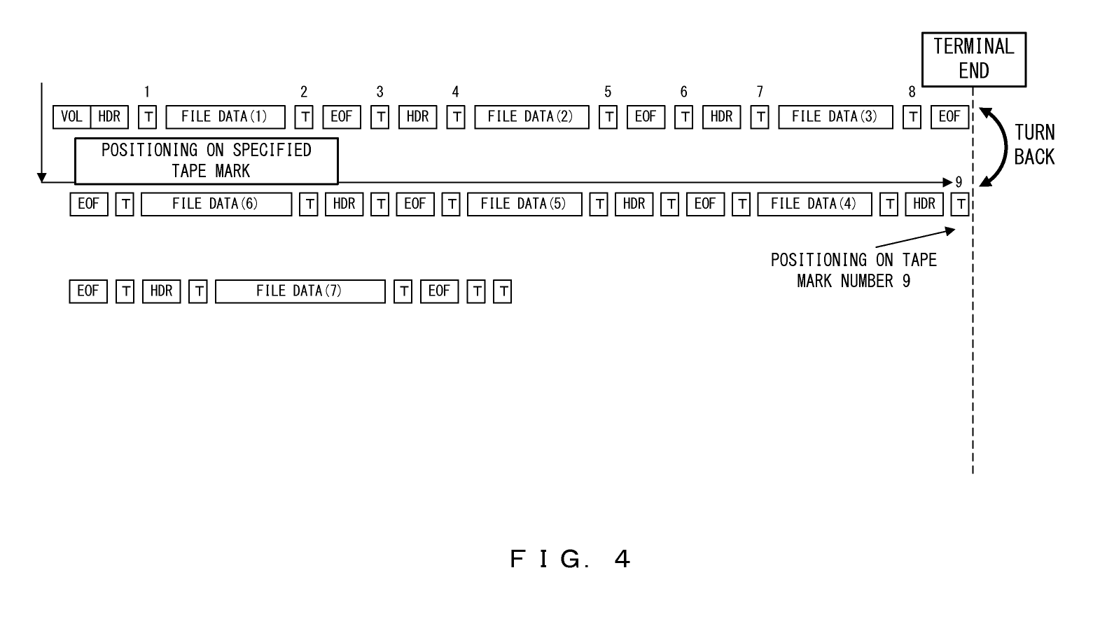

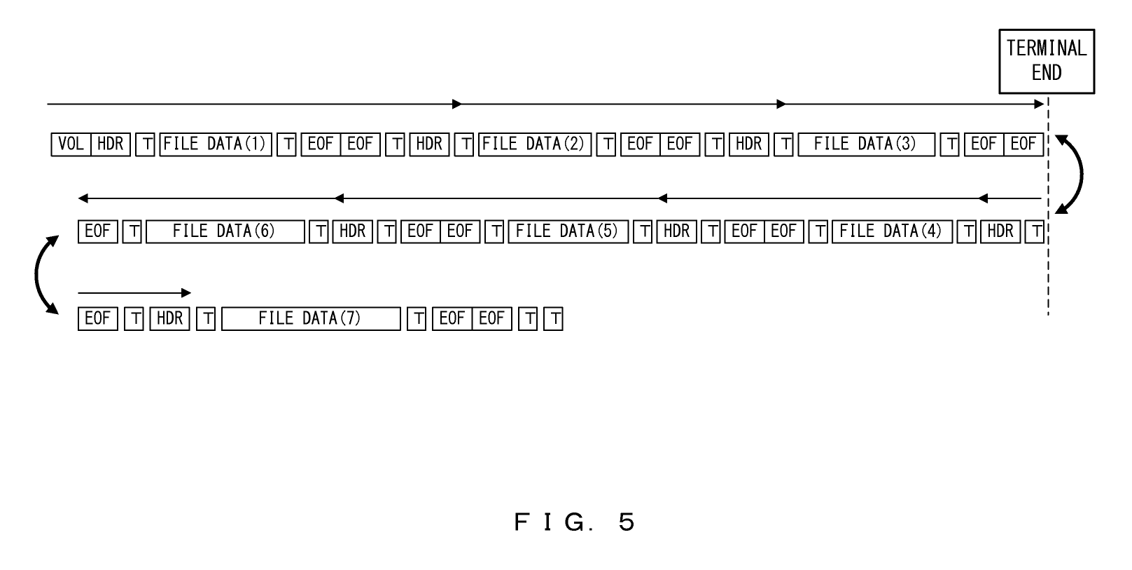

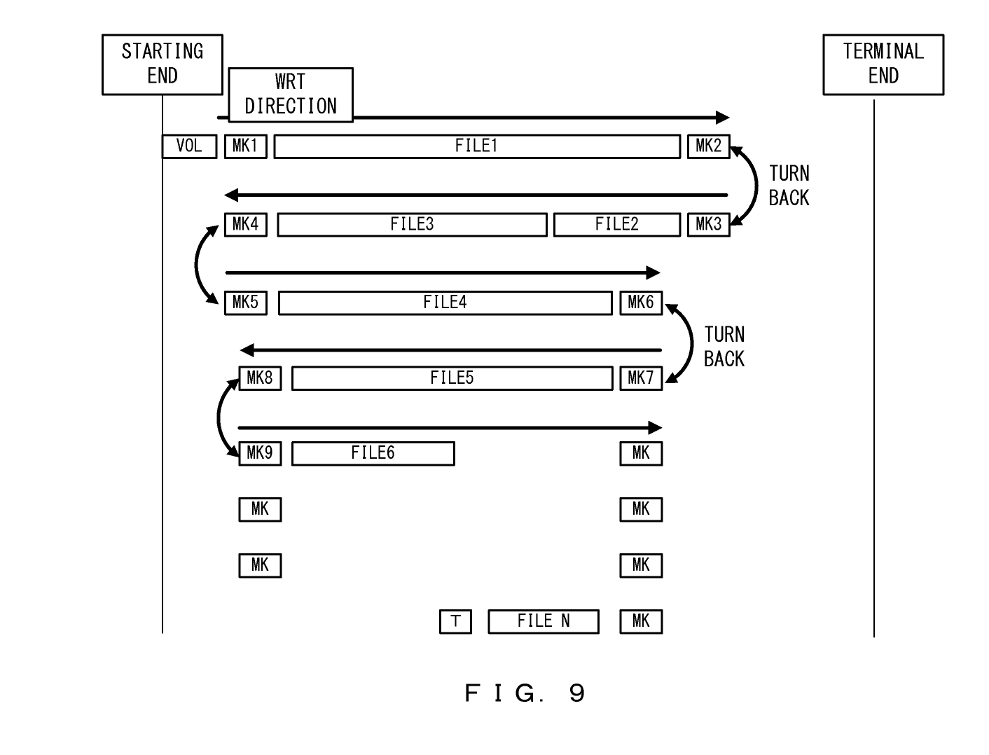

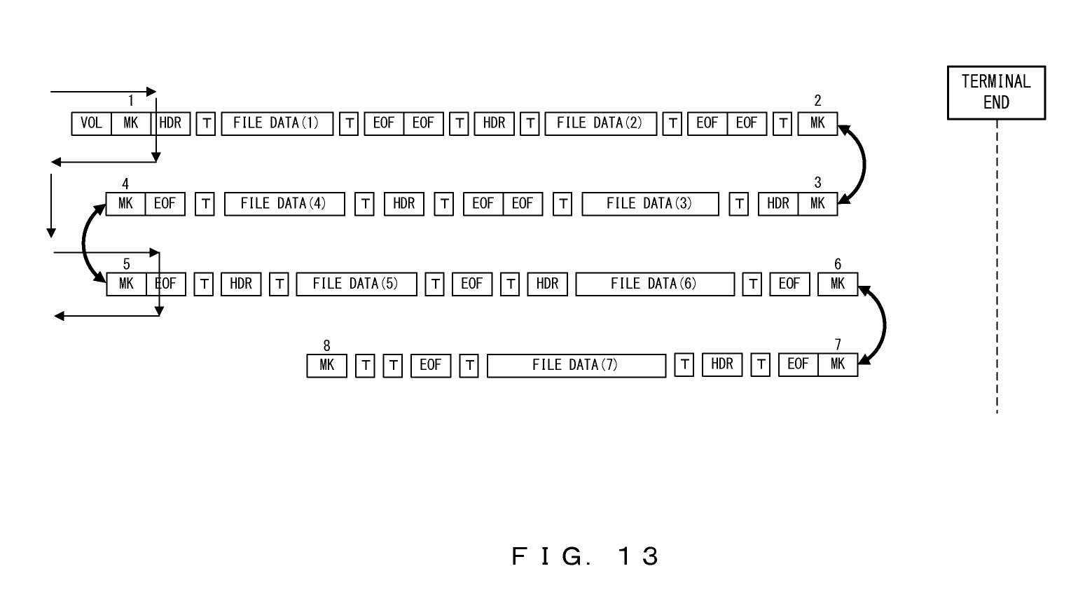

Next, the tape layout of the tape cartridge is explained. FIG. 3 illustrates an example of the tape layout. The arrow in the example in FIG. 3 indicates the movement of the position of the head of the drive. In the same manner as in FIG. 3, the arrow in subsequent FIG. 4-FIG. 5, FIG. 9-FIG. 11, and FIG. 13-FIG. 17 also indicates the movement of the position of the head of the drive.

Writing of data to the tape is performed in the running direction (the winding direction) of the tape, from the physical starting end to the terminal end of the tape. A path on the tape on which the writing of data is performed is called a track or a lap. A plurality of such laps in the running direction of the tape are provided in a direction (this direction being called the width direction) perpendicular to the running direction of the tape. In the explanation below, among the plurality of laps included in the tape, the lap to which the writing of data is performed last is referred to as the final lap. In addition, it is assumed that EOT is positioned at the terminal end of the final lap.

In the example in FIG. 3, for example, the writing of data is performed first from the starting end of the tape to lap 1, and when it reaches the terminal end of the tape, the writing position is shifted in the width direction of the tape, and the writing of data is performed from the terminal end to the starting end of the tape in lap 2. In the explanation below, the direction from the starting end to the terminal end of the tape is referred to as the forward direction, and the direction from the terminal end to the starting end of the tape is referred to as the backward direction. That is, the writing direction for lap 1 is the forward direction, and the writing direction of lap 2 is the backward direction.

When the writing of data in lap 2 is performed and when it reaches the starting end of the tape, a change to lap 3 is performed, the writing direction of data is changed from backward to forward, and the writing of data is performed. When the writing in lap 3 is completed, a change of the lap is performed in the same manner, turning back (reversing) the writing direction, and the writing of data is performed.

Then, when the writing of all write-target files for the tape cartridge is completed, lastly, T indicating data writing completion is written. In the example in FIG. 3, this T is recorded after file 8 of lap 5, where the writing of all the files is completed.

At this time, if it is assumed that the number of writable laps in the tape cartridge is ten, it follows that the writing of data is not performed in the remaining five laps. In a general-purpose machine system, it is unlikely that the entire storage capacity of the cartridge will be used up, and therefore, there may be a plurality of laps in which no data is written.

Next, the way in which a search for a file is performed in a layout such as the one in FIG. 3 in which the lap is turned back at the terminal end of the tape is explained. For a search for a file, there is a method in which a tape mark is used, and a method in which a file name is used, to specify the search-target file from the mainframe (hereinafter referred to as the host).

First, a search for a file using a tape mark is explained. In this method, to specify the search-target file, the number of the tape mark immediately before the HDR of the search-target file is specified by the host. Then, the control unit controls the drive so that the head that performs the reading of data is positioned at the position of the specified tape mark.

FIG. 4 illustrates an example of a search with the number of the tape mark being specified, in a layout such as the one in FIG. 4 in which the lap is turned back at the terminal end of the tape. Here, for example, it is assumed that tape mark number 9 (referred to as T9) is specified by the host. Then, first, the control unit performs a change to the lap in which the specified tape mark exists, and the control unit controls the drive so that the tape runs sequentially from the starting end of the lap to the position of the specified tape mark. When the specified tape mark is positioned at the terminal end of the tape as with T9 in the example of FIG. 4, the running distance of the tape is approximately the distance from the starting end to the terminal end of the tape.

Next, a search for a file with the file name being specified is explained. In this method, to specify the search-target file, the file name of the search target is specified from the host. When such a search request is received, the control unit performs a search for a file having the specified file name. That is, the control unit controls the drive so as to read HDR information stored on the tape from the starting end of lap 1 in the order of writing of data. Then, the control unit identifies an HDR corresponding to the specified file name, and controls positioning of the head of the drive at the position of the identified HDR.

FIG. 5 illustrates an example of a search with the search-target file name specified, in a layout such as the one in FIG. 4 in which the lap is turned back at the terminal end of the tape. FIG. 5 illustrates an example in which a file 7 is specified as the search-target file name.

As illustrated in FIG. 5, the control unit makes the tape run sequentially from lap 1, and the control unit sequentially judges whether or not the HDR recorded in each lap corresponds to the specified file name.

Specifically, first, the control unit makes the tape run from the starting end to the terminal end of lap 1, and the control unit sequentially judges whether or not an HDR recorded in lap 1 corresponds to the specified file name. When it reaches the terminal end of lap 1, the control unit changes the lap and makes the tape run from the terminal end to the starting end of lap 2, and in the same manner as for lap 1, the control unit sequentially judges whether or not an HDR recorded in lap 2 corresponds to the specified file name. In the same manner, the control unit makes the tape run from the starting end to the terminal end of lap 3, and the control unit sequentially judges whether or not an HDR recorded in lap 3 corresponds to the specified file name. Here, the control unit judges whether or not the HDR of file 7 recorded in lap 3 corresponds to the specified file name, and as a result, it judges that the HDR of file 7 corresponds to the specified file name. Then, the control unit positions the head of the drive at the position of the HDR of file 7.

Here, as with file 7 in the example in FIG. 5, the more to the rear in the order of writing the specified file is positioned in the data written on the tape, the longer is the running distance of the tape in the search for a file with the file name being specified.

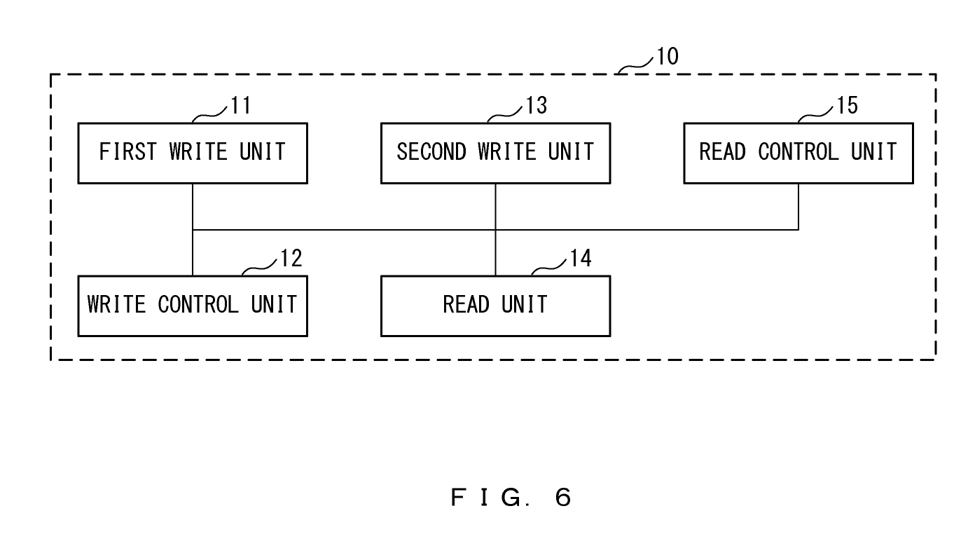

FIG. 6 illustrates an example of the configuration of the tape apparatus according to the present embodiment. In FIG. 6, the tape apparatus 10 includes a first write unit 11, a write control unit 12, a second write unit 13, a read unit 14, and a read control unit 15.

The first write unit 11 writes information into one of a plurality of tracks included in a first tape medium.

The write control unit 12 performs control to make the first write unit 11 write write-target information into a first track, and when the length from the position of the first write unit 11 to the start position of the first track is equal to or greater than a prescribed threshold, the write control unit 12 performs control to make the first write unit 11 write control information indicating the terminal end of the track, and to move the first write unit 11 to a second track. The control information includes information for identifying information recorded in each track. Here, the prescribed threshold is, for example, a value obtained by dividing the tape length in which the write-target information is stored by the number of tracks included in the first tape medium.

The second write unit 13 writes write-target information into a second tape medium that includes a plurality of tracks turned back at the starting end and the terminal end of the tape.

When the write control unit 12 detects the terminal end of the final track of the first tape medium during the writing of the write-target information into the first tape medium, the write control unit 12 performs control to overwrite the first tape medium with information recorded in a second tape medium. In addition, when the writing of the write-target information into the first tape medium is completed, the write control unit 12 performs control to overwrite the second tape medium with the information written in the first tape medium.

The read unit 14 reads information written in one of a plurality of tracks included in a tape medium.

The read control unit 15 performs control to make the read unit 14 read information recorded in the first track, and when control information is read, the read control unit 15 performs control to move the read unit 14 to the second track. Meanwhile, the read control unit 15 reads control information recorded on the starting-end side of the tape among the control information recorded in the track, and according to the control information the read control unit 15 has read, the read control unit 15 identifies information recorded in the track.

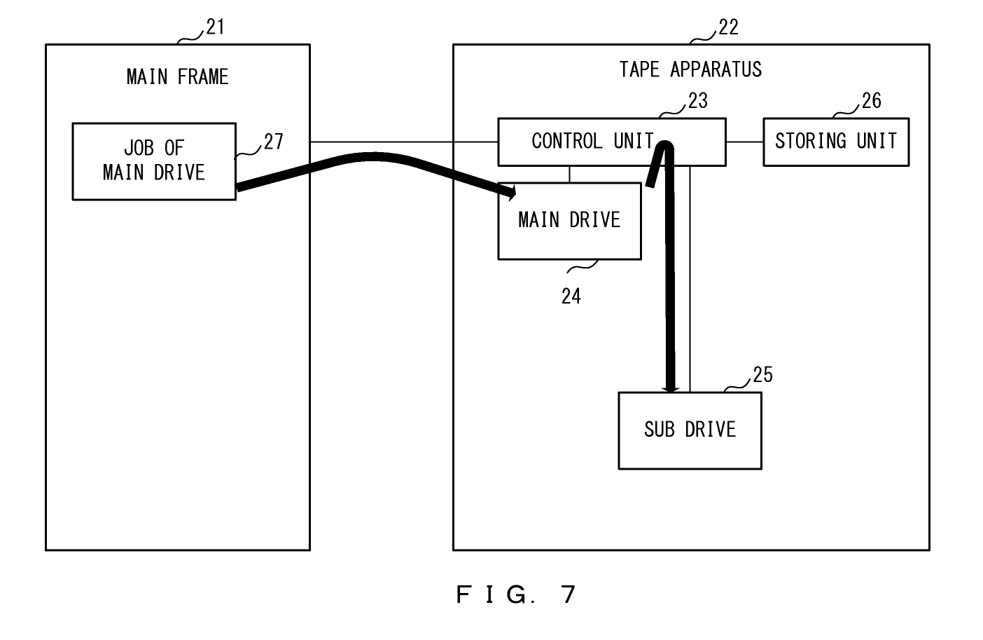

FIG. 7 illustrates an example of the configuration of an information processing system according to the present embodiment. In FIG. 7, the information processing system includes a mainframe 21 and a tape apparatus 22, and the mainframe 21 and the tape apparatus 22 are connected via a bus, a network or the like, for example. The mainframe 21 makes the tape cartridge set in the tape apparatus 22 store data, and the mainframe 21 also obtains data from the tape cartridge via the tape apparatus 22. In the present embodiment, the mainframe 21 is configured to make two tape cartridges, the main and the sub, store the same data.

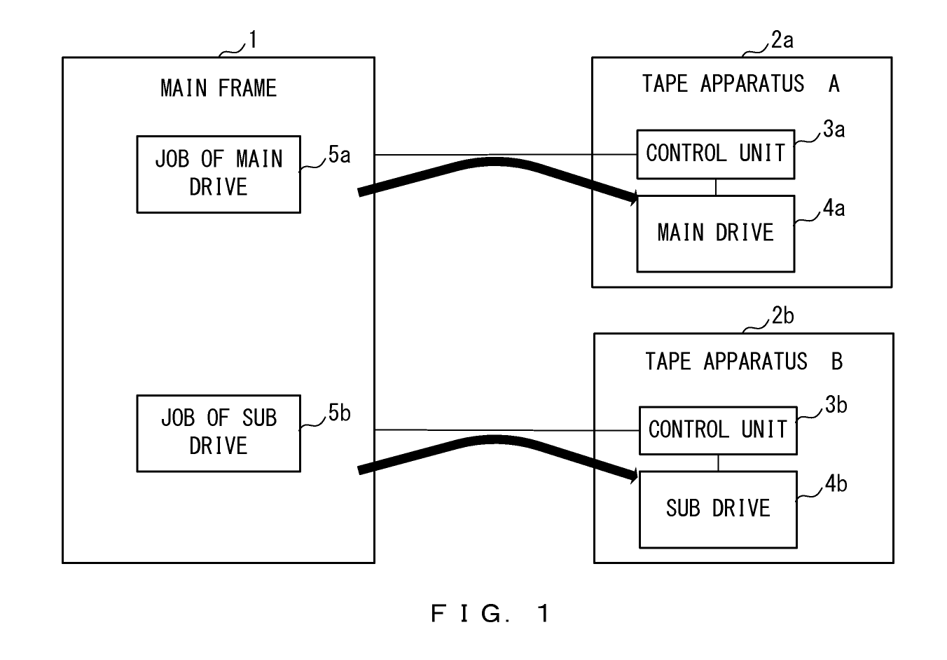

In the mainframe 21, a job 27 corresponding to the main drive for writing data into the main cartridge is executed. In the example in FIG. 1, two jobs are executed when writing data into the main and sub tape cartridges, but in the example in FIG. 7, one job is executed. In the information processing system in FIG. 7, the load of the write process imposed on the mainframe is reduced compared with that in the example in FIG. 1.

The tape apparatus 22 is compatible with insertion of two tape cartridges, and the tape apparatus 22 includes a control unit 23, a main drive 24, a sub drive 25 and a storage unit 26. Each of the main drive 24 and the sub drive 25 performs reading and writing from and into two tape cartridges inserted.

The tape apparatus 22 is an example of the tape apparatus 10. The control unit 23 is an example of the write control unit 12 and the read control unit 15. The head of the sub drive 25 is an example of the first write unit 11. The head of the main drive 24 is an example of the second write unit 13.

The tape apparatus 22 may write data received from the mainframe 21 into the main and sub cartridges simultaneously, or may store the data in the main cartridge first, and at a prescribed timing after that, the tape apparatus 22 may reproduce the data stored in the main cartridge in the sub cartridge.

The control unit 23 performs control regarding reading and writing of data from and into the tape cartridge.

Regarding the writing of data, specifically, the control unit 23 receives, from the mainframe 21, write-target data together with a write request for writing data into the tape cartridge. Then, the control unit 23 forwards the received data to the main drive 24 or to the sub drive 25, and the control unit 23 also controls the main drive 24 or the sub drive 25 so as to make it write the forwarded data into the main cartridge or the sub cartridge.

Regarding the reading of data, when the control unit 23 receives, from the mainframe 21, a read request for data stored in the tape cartridge, the control unit 23 controls the main drive 24 and the sub drive 25 so as to read data from the tape cartridge. Then, it obtains the data read by the main drive 24 and the sub drive 25 and forwards the obtained data to the mainframe 21.

The control unit 23 may reproduce the data stored in the main cartridge at a prescribed timing in the sub cartridge. That is, the control unit 23 may control the main drive 24 so as to read data from the main cartridge and may control the sub drive 25 so as to write the read data into the sub cartridge.

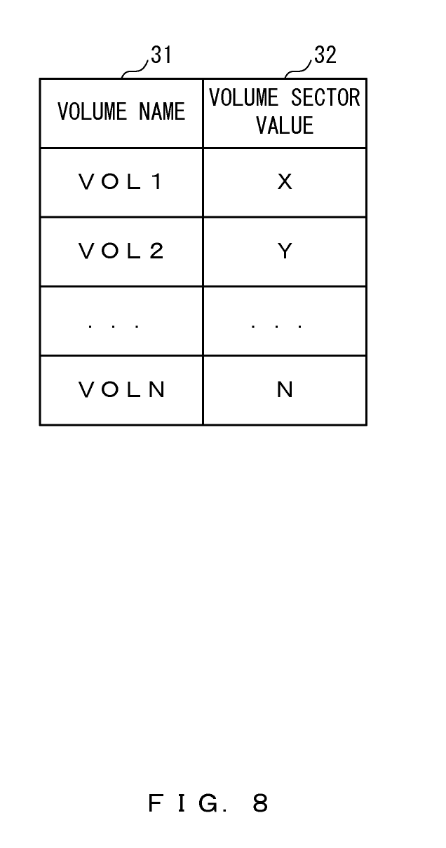

The storage unit 26 stores various temporary variables used by the control unit 23 when writing data to the tape. In addition, the storage unit 26 stores volume information in which identification information of a volume for which the write process that writes into the tape cartridge has been performed in the tape apparatus 22 before is associated with the size of the volume. FIG. 8 is a diagram illustrating an example of volume information. In FIG. 8, volume information includes data items comprising a volume name 31 and a volume sector value 32. The volume name 31 is identification information for uniquely identifying a volume for which the tape apparatus 22 has performed the write process that writes into the tape cartridge before. The volume name may correspond to a VOL label written into the tape cartridge. The volume sector value 32 is a value that expresses, in a sector value, the tape length used when all the data in of the volume indicated by the volume name is written into the tape cartridge. The tape length may also be regarded as the distance on the tape for which the head of the drive moved.

When the writing of the write-target data is completed, the control unit 23 associates the volume name of the write-target data with a value that expresses, as a sector value, the tape length used when the write-target data was written, and the control unit 23 stores these in the volume information.

The example in FIG. 7 illustrates an example in which data in the mainframe 21 is written into the main cartridge set in the main drive 24, and after that, the data stored in the main cartridge is reproduced in the sub cartridge set in the sub drive 25. As illustrated in FIG. 7, in the mainframe 21, a job corresponding to the main drive 24 is executed, and the job transmits write-target data together with a write request for the data to the control unit 23 of the tape apparatus. Upon receiving the write-target data, the control unit 23 forwards the received data to the main drive 24. Upon receiving data from the control unit 23, the main drive 24 stores the received data in the main cartridge set in the main drive 24.

After that, the following reproducing process is performed. That is, the control unit 23 controls the main drive 24 so as to read data from the main cartridge and the control unit 23 obtains the read data from the main drive 24. Then, the control unit 23 forwards the obtained data to the sub drive 25 and also controls the sub drive 25 so as to write the forwarded data into the sub cartridge.

Next, the tape layout of a tape cartridge according to the present embodiment is explained. The tape layout of the main cartridge set in the main drive 24 is the same as the one explained in FIG. 3, but the tape layout of the sub cartridge set in the sub drive 25 is different from the one explained in FIG. 3. In the tape layout of the sub cartridge according to the present embodiment, the turning-back position of the tape is not at the terminal end but is changed according to the total amount of data stored in the tape.

FIG. 9 illustrates an example of the tape layout of the sub cartridge according to the present embodiment. As illustrated in FIG. 9, the turning-back position of each lap is a position between the starting end and the terminal end of the tape. As illustrated in FIG. 9, a control mark (MK 1, MK 2, . . . ) is placed at the start position and at the end position of each lap. The turning-back position is managed by this control mark.

Here, the method to determine the turning-back position of each lap is explained. In the present embodiment, the turning-back position is determined so that the amount of data stored in each lap of the sub cartridge is even. However, the turning-back position is not located in the middle of a file, but is located between two files.

The method to determine the turning-back position of each lap is different for a case in which the total amount of data to be stored in the sub cartridge is known and for a case the total amount is unknown. First, a case in which the total amount of data to be stored in the sub cartridge is known is explained.

In determining the turning-back position of each lap, when the total amount of data to be stored in the sub cartridge is known, the control unit 23 first calculates the sector value of the total tape length of the storage area in a case in which the sub cartridge stores the total amount of data to be stored in the sub cartridge . Then, the control unit 23 divides the value calculated here by the total number of laps of the sub cartridge, and the value of the result the division is obtained as the average sector value.

For example, when the total sector value of data to be stored in the sub cartridge is “10,000” and the total number of laps of the cartridge is “20”, the average sector value is “500”.

When the average sector value has been calculated, the control unit 23 next identifies a position on each lap at which the value that expresses the tape length from the start position of each lap as a sector value becomes equal to the average sector value. Then, the control unit 23 determines the writing end position of the file that includes the block (data) stored at the identified position as the turning-back position of the lap. In the explanation below, the value that expresses the tape length as a sector value is simply referred to as a sector value.

For example, in the example in FIG. 9, when the average sector value is “500” and the sector value from the writing end position of file 1 to the starting end of the tape is “700”, the control unit 23 determines the writing end position of file 1 to be the turning-back position. While a specific explanation is given later, the control unit 23 compares the sector value from the writing end position of the file to the starting end of the lap with the average sector value each time writing of the file is completed. Then, according to the result of the comparison, the control unit 23 judges whether or not the writing end position of the file is the turning-back position.

For lap 2, the control unit 23 determines the turning-back position in the same manner as for lap 1. For example, in the example in FIG. 9, it is assumed that the sector value from the writing end position of file 2 to the start position of lap 2 is “200” and the sector value from the writing end position of file 3 to the start position of lap 3 is “700”. In this case, the control unit 23 determines the writing end position of file 3 to be the turning-back position.

When the total amount of data to be stored in the sub cartridge is known, the turning-back position is determined as described above.

As an example of a case in which the total amount of data to be stored in the cartridge is known, there is a case in which data that has the same volume name as the write-target volume has been written into the tape cartridge by the tape apparatus 22 before. In such a case, it follows that a record whose value of the volume name 31 is equal to the volume name of the write-target volume exists in volume information stored in the storage unit 26. Then, the control unit 23 extracts the record whose value of the volume name 31 is equal to the write-target volume name and the control unit 23 obtains the volume sector value 32 of the extracted record. Then, the control unit 23 calculates a value obtained by dividing the obtained volume sector value by the total number of laps of the sub cartridge as the average sector value.

Next, the method to determine the turning-back position of each lap in a case in which the total amount of data to be stored in the cartridge is unknown is explained. In determining the turning-back position of each lap, when the total amount of data to be stored in the cartridge is unknown, the control unit 23 first calculates a value that is ½ of the sector value corresponding to the tape length from the starting end to the terminal end of the tape as the average sector value. In the present embodiment, a value that is ½ of the sector value corresponding to the tape length from the starting end to the terminal end of the tape is calculated as the average sector value, but the average sector value may also be a prescribed tape length in the tape length from the starting end to the terminal end of the tape.

For example, when the sector value corresponding to the tape length from the starting end to the terminal end of the tape is “800”, the average sector value is “400”, which is ½ of “800”.

When the average sector value has been calculated, the control unit 23 next identifies a position on each lap at which the sector value from the start position of each lap becomes equal to the average sector value in the same manner as in the case in which the total amount of data to be stored in the cartridge is known. Then, the control unit 23 determines the end position of a file that includes the block (data) stored at the identified position as the turning-back position of the lap.

The turning-back position of the tape cartridge is determined as described above. When the turning-back position is determined, the control unit 23 inserts, at the determined turning-back position, a control mark to indicate that it is the turning-back position. When the head of the sub drive 25 detects the control mark while reading data, a change of the lap is performed at the detected position and the running direction of the tape is turned back (reversed).

The control unit 23 also inserts the control mark at the start position of each lap. That is, it follows that, in the present embodiment, the control mark is to be recorded at the start position and at the end position of each lap included in the sub cartridge.

For a lap into which data is written in forward order (forward direction), the start position of the lap is at the position of the starting-end side of the tape, and for a lap into which data is written in backward order (backward direction), the start position is at the position of the terminal-end side of the tape. In addition, for a lap into which data is written in forward order, the end position of the lap is at the position of the terminal-end side of the tape, and for a lap into which data is written in backward order, the end position is at the position of the starting-end side of the tape.

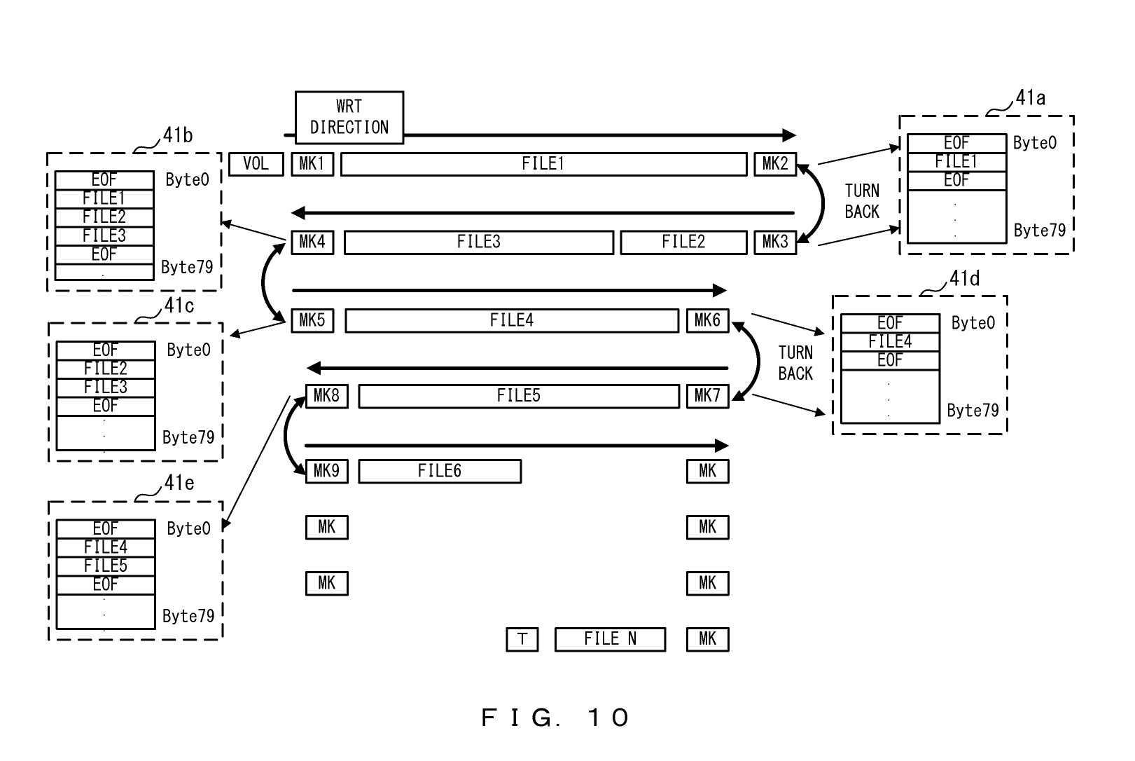

In the data structure of a control mark, the structure of data is different for the one that is inserted at the start position of each lap and for the one that is inserted at the end position. Furthermore, in the control mark inserted at the end position, the structure of data is different for a lap into which data is written in forward order and for a lap into which data is written in backward order. Hereinafter, referring to FIG. 10, the structure of the control mark in each case is explained. FIG. 10 is a diagram for explaining the data structure of the control mark.

First, the data structure of the control mark inserted at the start position of each lap is explained. The control marks inserted at the start position of each lap are, in the example in FIG. 10, MK 1, MK 3 (41a), MK 5 (41c), MK 7 (41d), MK 9, . . . . As illustrated in FIG. 10, the control mark inserted at the start position of the lap includes the file name of the file recorded in the immediately-preceding lap. Here, focusing on a given lap for explanation and referring to the lap focused upon as a focus lap A, the control mark inserted at the start position of the focus lap A includes the file name of a file stored in the lap before (immediately before) the change to the focus lap A.

Specifically, in FIG. 10 for example, the control mark MK 3 inserted at the start position of lap 2 includes the file name of file 1 which is a file recorded in lap 1. Meanwhile, the control mark MK 5 inserted at the start position of lap 3 includes the file names of file 2 and file 3 which are files recorded in lap 2.

Next, the data structure of the control mark which is inserted at the end position of a lap and which is a control mark inserted in a lap into which data is written in forward order is explained. The control marks inserted at the end position of a lap into which data is written in forward order are, in the example in FIG. 10, MK 2 (41a), MK 6 (41d), . . . . As illustrated in FIG. 10, The control mark inserted at the end position of a lap into which data is written in forward order includes the file name of a file recorded in the lap in which the control mark is inserted. Here, focusing on a given lap into which data is written in forward order and referring to the lap focused upon as a focus lap B, the control mark inserted at the end position of the focus lap B includes the file name of the file stored in the focus lap B.

Specifically, in the example in FIG. 10, the control mark MK 2 inserted at the end position of lap 1 includes the file name of file 1 which is the file stored in lap 1. In addition, the control mark MK6 inserted at the end position of lap 3 includes the file name of file 4 which is the file stored in lap 3.

Next, the data structure of a control mark which is inserted at the end position of a lap and which is a control mark inserted in a lap into which data is written in backward order is explained. The control marks inserted at the end position of a lap into which data is written in backward order are, in the example in FIG. 10, MK 4 (41b), MK 8 (41e), . . . . The control marks inserted at the end position of a lap in which data is written in backward order include the file name of a file recorded in the lap in which the control mark is inserted, and the file name of the file recorded in the lap immediately preceding the lap into which the control mark inserted. Here, focusing on a given lap into which data is written in backward order and referring to the lap focused upon as a focus lap C, the control mark inserted at the end position of the focus lap C includes the file name of a file stored in the focus lap C and the file name of a file stored in the lap before (immediately before) the change to the focus lap C.

Specifically, in the example in FIG. 10, the control mark MK 4 inserted at the end position of lap 2 includes the file names of files 2 and 3 which are files stored in lap 2, and file 1 which is a file stored in lap 1. In addition, the control mark MK 8 inserted at the end position of lap 4 includes the file name of file 5 which is the file stored in lap 4, and the file name of file 4 which is a file stored in lap 3.

The turning-back position is between two files in the present embodiment because, for example, when the file data is important data, it is not desirable to insert a control mark in the middle of the file data from the standpoint of the reliability of the data. When reliability is not required for the file data and there is no particular problem in inserting the control mark in the middle of the file data, the control mark may be inserted at a prescribed position. In that case, it becomes possible to use the tape more efficiently.

Next, writing of data into the sub cartridge is explained. When writing data into the sub cartridge, the control unit 23 performs the writing of data so as to provide the tape layout explained in FIG. 9. In the explanation below, a value that expresses the tape length from the start position of the write-target lap to a completion position at which the writing of data into the lap is completed as a sector value is referred to as a write sector value.

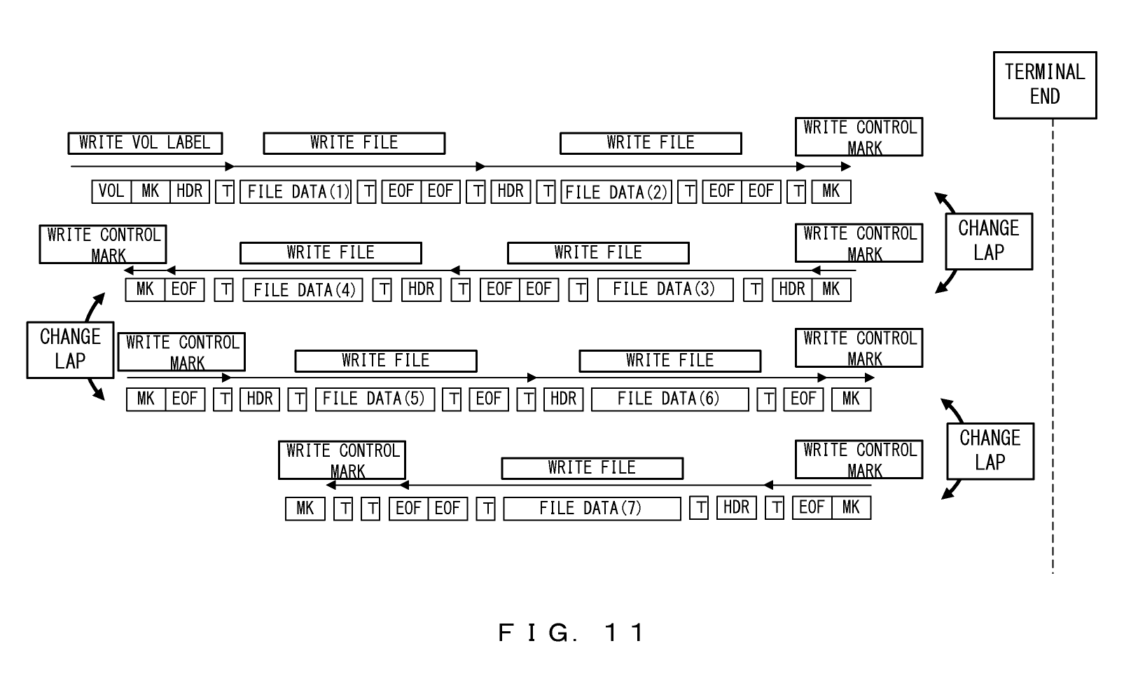

FIG. 11 is a diagram for explaining writing of data into the sub cartridge in the present embodiment.

In writing data, specifically, the control unit 23 performs writing of a VOL label among the write-target data first, and following that, the control unit 23 writes a control mark (indicated as MK in FIG. 11) at the start position of lap 1. Then, the control unit 23 performs writing of file 1 following the writing of the control mark. When the writing of file 1 is completed, the control unit 23 compares the write sector value and the average sector value. Here, when it is judged that the write sector value is smaller than the average sector value, the control unit 23 performs writing of the next file 2 in the same lap 1 next to file 1. Then, when the writing of file 2 is completed, the control unit 23 compares the write sector value and the average sector value again. Here, when it is judged that the write sector value is smaller than the average sector value, the control unit 23 further performs writing of the next file next to the written file in the same manner in the same lap 1.

Thus, when writing of a file is completed, a comparison of the write sector value and the average sector value is performed, and when it is judged that the write sector value is smaller than the average sector value at this time, the control unit 23 repeats in the same manner the operation of writing the next file successively in the same lap.

When it is judged that the write sector value is equal to or greater than the average sector value in the comparison at the end of writing of the file, the control unit 23 judges that the position of the head at the point of time when the writing of the file is completed is the turning-back position. Then, the control unit 23 writes a control mark next to the written file and performs a change to lap 2 which is the next lap. In this change, the change to lap 2 is performed by shifting the position of the head in the width direction of the tape, but the head is not shifted in the running direction of the tape.

The example in FIG. 11 illustrates an example in which the write sector value is equal to or greater than the average sector value in the comparison of the write sector value and the average sector value at the end of writing of file 2. Accordingly, a control mark is written next to file 2, and a change of the lap is performed.

When the change to lap 2 has been performed, the control unit 23 writes a control mark at the start position of lap 2, and then performs writing of a new file. When the writing of the file is completed, the control unit 23 compares the write sector value and the average sector value. When it is judged that the write sector value is smaller than the average sector value, the control unit 23 repeats the operation of writing the next file successively in the same lap in the same manner as in lap 1. Also, when it is judged that the write sector value is equal to or greater than the average sector value, the control unit 23 writes a control mark next to the written file and performs a change to the next lap, in the same manner as in lap 1. The operations for lap 3 and subsequent laps are the same as those for lap 2.

Next, a search for a file recorded in the sub cartridge is explained. As described above, for a search for a file, there are methods such as a method in which a tape mark is used, and a method in which a file name is used, to specify the search-target file.

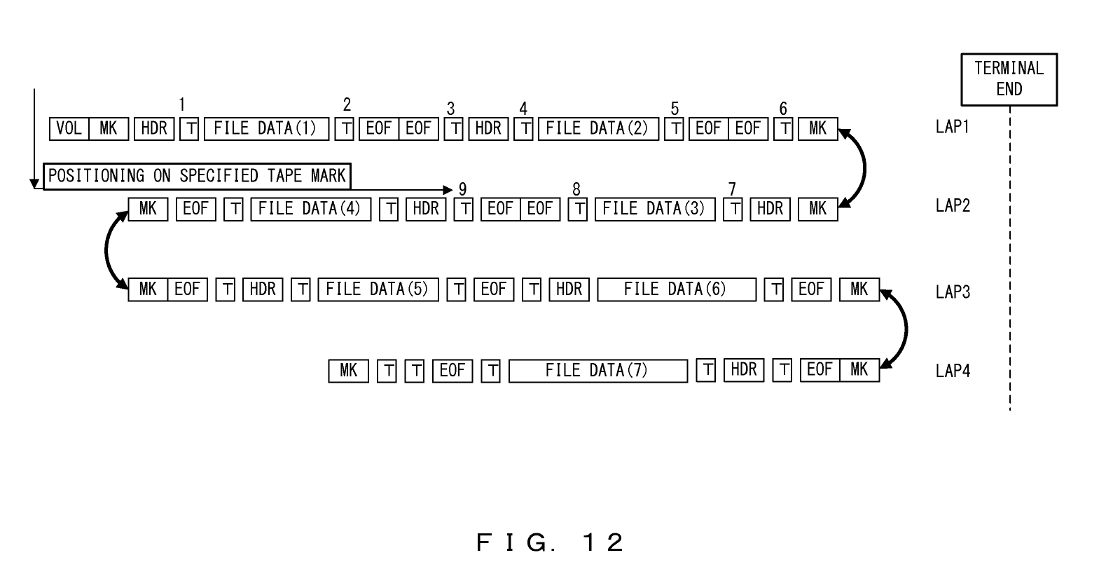

FIG. 12 illustrates a search for a file in the sub cartridge using a tape mark. A case in which tape mark number 9 is specified as the read-target file is explained.

First, the control unit 23 performs a change to the lap in which the specified tape mark exists and the control unit 23 makes the tape run sequentially from the starting-end side of the tape to the position of the specified tape mark.

Specifically, the control unit 23 first performs a change to lap 2 and makes the tape run to the position of tape mark number 9 to position the head of the drive.

Here, regarding a search for a file using a tape mark, the examples in FIG. 4 and FIG. 12 are compared.

In FIG. 4, for example, when the tape mark specified by the host is positioned at the terminal end of the tape, the running distance of the tape is the distance between the starting end and the terminal end of the tape. By contrast, in FIG. 12, tape marks are recorded from the start end of the tape to the turning-back position of the lap. Therefore, the running distance of the tape in the example in FIG. 12 is shorter than the running distance of the tape in the example in FIG. 4. Therefore, the search time in the sub cartridge for a file with a tape mark specified is shorter than the search time in the main cartridge.

Next, a search for a file with the file name being specified is explained. In this method, to specify the search-target file, the search-target file name is specified by the host.

FIG. 13 illustrates a search for a file in the sub cartridge using the file name. As illustrated in FIG. 13, the control unit 23 first issues an instruction to the drive to read the control mark on the tape starting-end side of each lap, and the control unit 23 identifies the lap in which the search-file target is recorded, according to the content of the read control marks. Then, the control unit 23 controls the drive to position the head at the front position of the file of the identified lap.

There are three patterns in the structure of the control mark on the cartridge starting-end side as explained with reference to FIG. 10, and the content of the control mark differs depending on the pattern, and therefore, how the read-target file is identified differs depending on the lap. In the explanation below, a lap in which data is recorded in forward order is referred to as a forward-order lap, and a lap in which data is recorded in backward order is referred to as a backward-order lap.

First, identification of whether or not the search-target file is included in a backward-order lap is explained. Here, for the purpose of explanation, the lap for which the judgment as to whether or not the search-target file is included is made is referred to as target lap D. As explained with reference to FIG. 10, the control mark recorded at the start position of the forward-order lap next to the target lap D includes the file name of the file recorded in the target lap which is the immediately preceding lap. Therefore, the control unit 23 judges whether the search-target data is recorded in target lap D by judging whether or not the search-target file is included in the control mark at the start position of the forward-order lap next to target lap D.

Next, identification of whether or not the search-target file is included in a forward-order lap is explained. Here, for the purpose of explanation, the forward-order lap for which the judgment as to whether or not the search-target file is included is made is referred to as target lap E, the lap next to target lap E is referred as lap F, and the lap next to lap F is referred to as lap G. Then, as explained with reference to FIG. 10, the control mark MK (F) recorded at the end position (the starting-end side of the tape) of backward-order lap F next to target lap E includes the file names of the files recorded in target lap E and in lap F. Also, the control mark MK (G) recorded at the start position of forward-order lap G includes, as explained with reference to FIG. 10, the file name of the file recorded in lap F. Therefore, when the control mark MK (F) recorded at the end position in lap F does not include the search-target file name, the control unit 23 judges that the search-target file is not recorded in target lap E. Also, when the control mark MK (F) at the end position of lap F includes the search-target file name and the control mark (G) at the start position of lap G does not include the file name of the search-target file, the control unit 23 judges that the search-target file is recorded in target lap E.

Here, the operations in a case of searching for file 4 is explained in FIG. 13. The control unit 23 first reads the control mark MK1 of lap 1. MK 1 does not include any file name, and therefore, the control unit 23 performs a change to lap 2, which is the next lap, and reads control mark MK 4. The reading of MK 1 may be omitted because MK 1 does not include any file name.

Next, upon reading control mark MK 4, the control unit 23 judges whether or not the file name of file 4 is included in control mark MK4. In the example in FIG. 13, file 4 is recorded in lap 2, and therefore, the control unit 23 judges that the file name of file 4 is included in control mark MK 4. Then, the control unit 23 judges that file 4 is recorded either in lap 2 which is the lap in which control mark MK 4 is recorded, or in lap 1 which is its immediately-preceding lap.

Then, the control unit 23 performs a change to lap 3 which is the next lap, and the control unit 23 reads control mark MK 5 and judges whether or not the file name of file 4 is included in control mark MK 5. Here, the control unit 23 judges that MK 5 includes the file name of file 4. Then, the control unit 23 judges that file 4 is recorded in lap 2. This is because control mark MK 5 is a control mark inserted at the start position of a lap, and such a control mark includes, as illustrated in FIG. 10, the file name of the file recorded in the lap immediately before the change of the lap in which the control mark is recorded.

When the lap in which the search-target file is recorded has been identified, the control unit 23 controls the drive to make the identified lap run and to position the head at the front position of the search-target file.

Here, regarding a search for a file using the file name, the examples in FIG. 5 and FIG. 13 are compared.

In FIG. 5, scanning of the tape is performed sequentially from lap 1 until an HDR corresponding to the search-target file name is read. By contrast, in FIG. 13, the running distance of the tape is shorter because the lap in which the search-target file is recorded is identified first using control information recorded at the starting-end side of the tape, and reading of the HDR is performed in the identified lap. Therefore, the search time for a file in the sub cartridge with the file name being specified is shorter than that in the main cartridge.

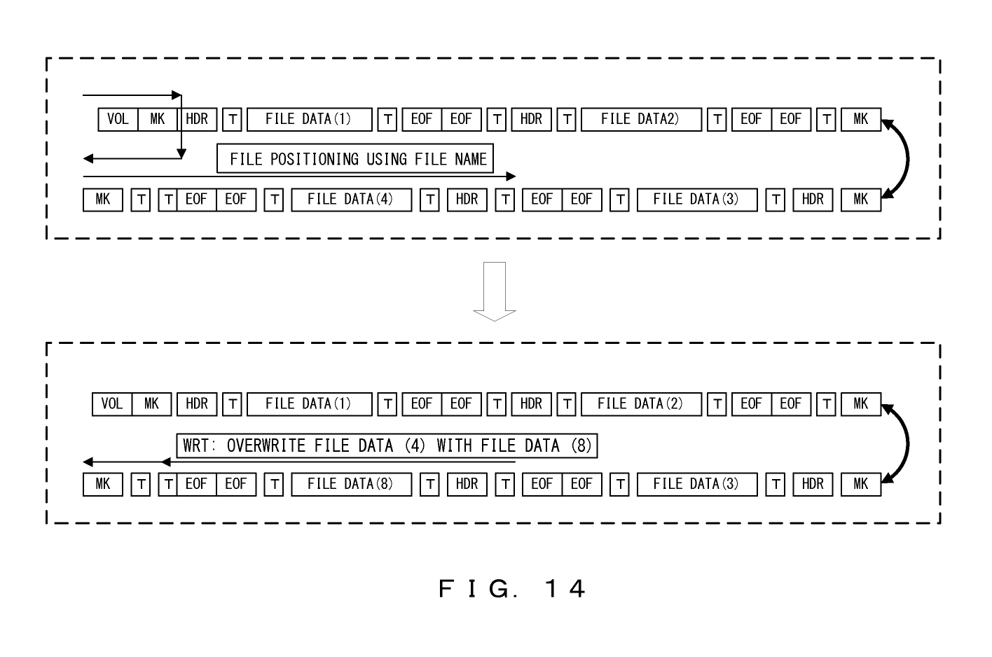

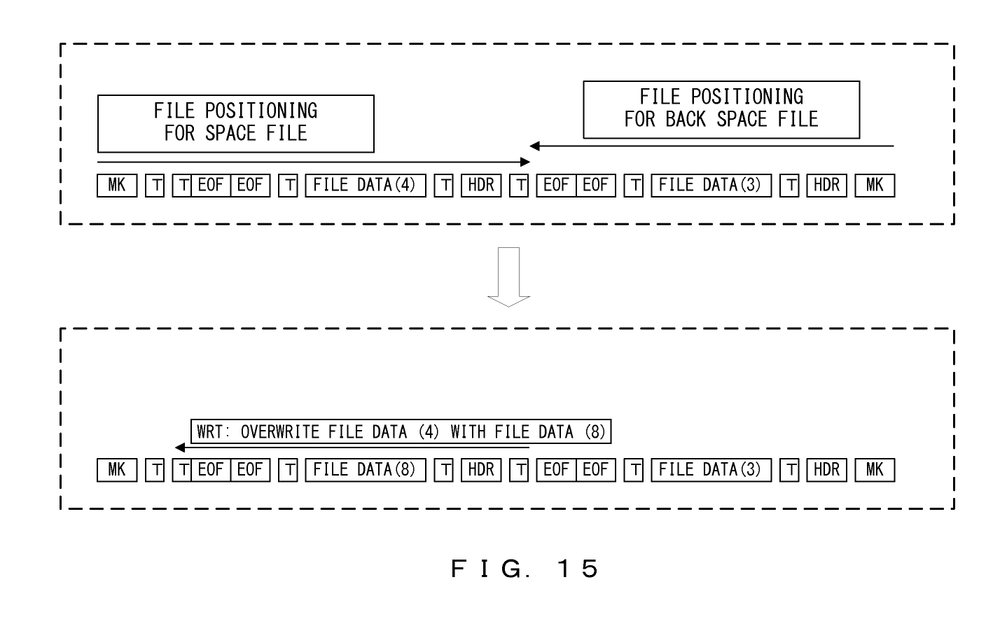

Next, the operation of overwriting data on a file that has already been written into a cartridge is explained using FIG. 14 and FIG. 15.

FIG. 14 is a diagram illustrating the way in which a search for an overwrite-target file using the file name is performed and then overwriting is performed. FIG. 14 illustrates the way in which file 4 which has already been stored is overwritten with file 8.

First, the control unit 23 performs a search for file 4 which is the overwrite target. Here, file 4 is specified by the host as the search-target file. The method of the search for file 4 is the same as that explained using FIG. 13. When positioning of the head of the drive at the front position of file 4 is completed, the control unit 23 overwrites file 4 with file 8.

FIG. 15 illustrates the way in which a search for an overwrite-target file using a tape mark is performed, and then overwriting of the file is performed. FIG. 15 illustrates the way in which file 4 which has already been stored is overwritten with file 8.

First, the control unit 23 performs a search for file 4 which is the overwrite target. Here, the tape mark positioned before file 4 is specified by the host. The method of the search for file 4 is the same as that explained using FIG. 12. When positioning of the head of the drive at the front position of file 4 is completed, the control unit 23 overwrites file 4 with file 8.

For a search for a file using a tape mark, there is a case in which the search is performed in the forward direction of the tape (space file) as illustrated in FIG. 15, and a case in which the search is performed in the backward direction of the tape (backspace file).

Next, changing of the turning-back position in the sub cartridge is explained. When the amount of data to be recorded in the sub cartridge is not known in advance, there is a case in which it is impossible to write all the data, depending on the amount of write-target data. In addition, when adding a file into the sub cartridge, there is also a case in which it is impossible to write all the data, depending on the size of the file to be added. In such a case, the control unit 23 stores all the write-target data into the sub cartridge by changing the turning-back position in the sub cartridge.

In the present embodiment, the same write-target data is recorded in the main cartridge and the sub cartridge. Here, the operations at the time when the write-target data is simultaneously written into the main cartridge and the sub cartridge are explained.

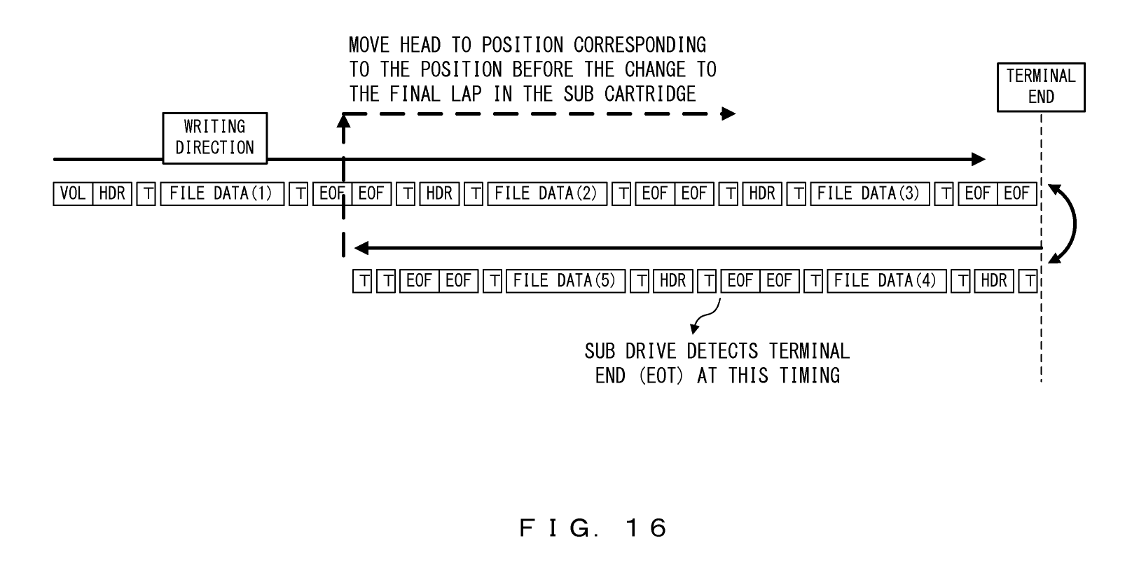

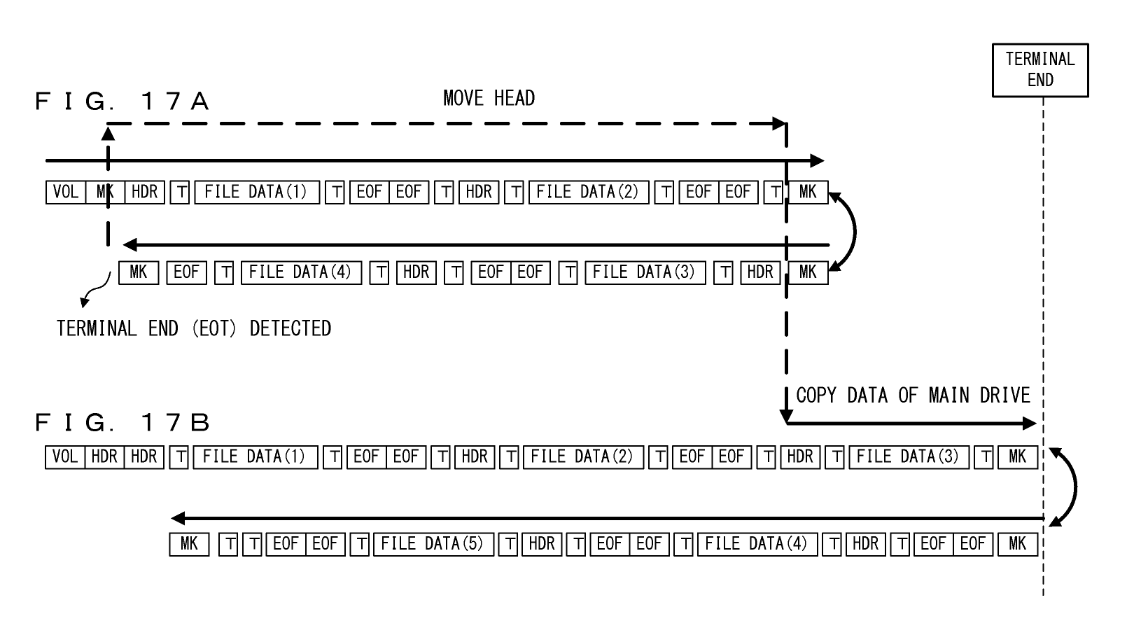

FIG. 16 and FIG. 17A, 17B are diagrams for explaining a change of the turning-back position in the sub cartridge. FIG.

16 illustrates the way in which write-target data is written into the main cartridge. FIG. 17A illustrates the way in which write-target data is written into the sub cartridge first, and EOT is detected during the writing. FIG. 17B illustrates the way in which the write-target data is written into the sub cartridge again after changing the turning-back position.

First, the control unit 23 performs writing of the write-target files into the main and sub cartridges set in the main drive 24 and the sub drive 25, as illustrated in FIG. 16 and FIG. 17A. Here, together with the writing of the files, the control unit 23 records the sector value of the main cartridge into which the write-target files have been written.

After that, as the writing into the sub drive 25 progresses, a change to the final lap is performed. At the time of the change to the final lap, the control unit 23 stores the block ID of the block that was last written before the change, in the storage unit 26. The block ID is identification information for uniquely identifying each block included in the write-target data.

Then, as illustrated in FIG. 17A, upon detecting EOT during the writing of the write-target data into the sub cartridge, the control unit 23 stops the writing of the data into the sub cartridge . While the writing into the sub cartridge stops, as illustrated in FIG. 16, the writing into the main cartridge is continued, and all the write-target data is written into the main cartridge.

In FIG. 16, when the writing of all the write-target data into the main cartridge has been completed, the control unit 23 moves the head of the main drive 24 to a position corresponding to the position before the change to the final lap in the sub cartridge. Specifically, the control unit 23 first obtains the block ID of the block that was last written before the change to the final lap in the sub cartridge. Then, the control unit 23 positions the head of the main drive 24 at the position in the main cartridge at which the block that has the obtained block ID is stored.

Meanwhile, as illustrated in FIG. 17B, the control unit 23 positions the head of the sub drive 25 at the position at which the block that was last written before the change to the final lap in the sub cartridge was written.

Then, the control unit 23 changes the turning-back position so that all the write-target files may be written into the sub cartridge, according to the sector value of the write-target files written into the main cartridge. Specifically, the control unit 23 determines the turning-back position by setting a value that is ½ of the sector value of the write-target files written into the main cartridge as the average sector value.

Then, the control unit 23 performs reading of the file from the position of the head of the main drive 24 on which positioning has been performed. Then, as illustrated in FIG. 17B, the control unit 23 performs overwriting on the data in the sub cartridge with the data that was read from the main drive 24 from the position of the head of the sub drive 25 on which the positioning has been performed as the starting point of re-writing.

In the re-writing of data, in the same manner as in the writing of data, the control unit 23 identifies the position in the lap at which the sector value from the starting point of the lap becomes equal to the average sector value. Then, the control unit 23 changes the lap at the end position of the file in which the block (data) stored at the identified position is included.

In the change of the turning back position, the position to which the head is to be moved after the completion of the writing of all the write-target data into the main cartridge may be the position of the block of the HDR of the file that is first written among the write-target files. In that case, at the time of the write process that writes into the main cartridge, the control unit 23 records the block ID of the HDR of the file that is first written among the write-target files, in the storage unit 26, and the control unit identifies the position to which the head is to be moved according to this block ID. In addition, in this case, the average sector value in the re-writing may be a value obtained by dividing the sector value of the write-target files written into the main cartridge by the number of laps from the lap from which the re-writing starts to the final lap.

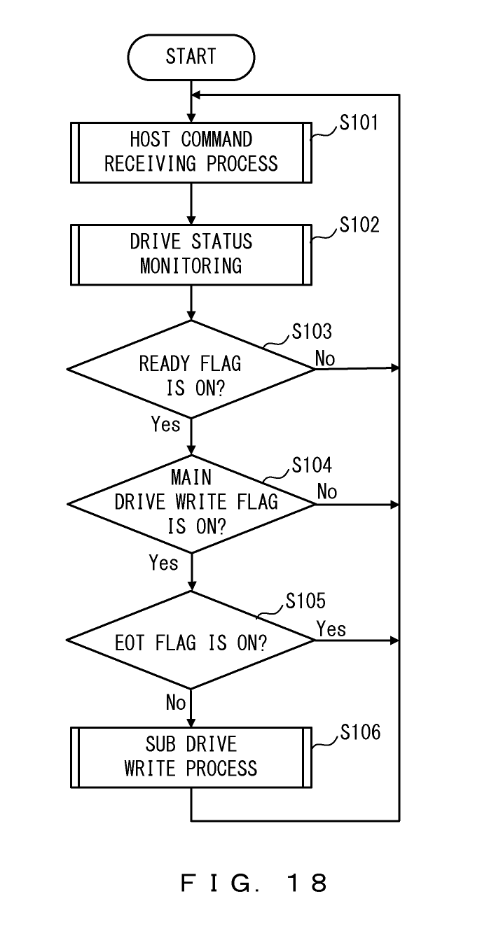

Next, the operation flow of the control unit 23 according to the present embodiment is explained with reference to FIG. 18-FIG. 27. FIG. 18 is a flowchart that illustrates the overall operation flow of the control unit 23.

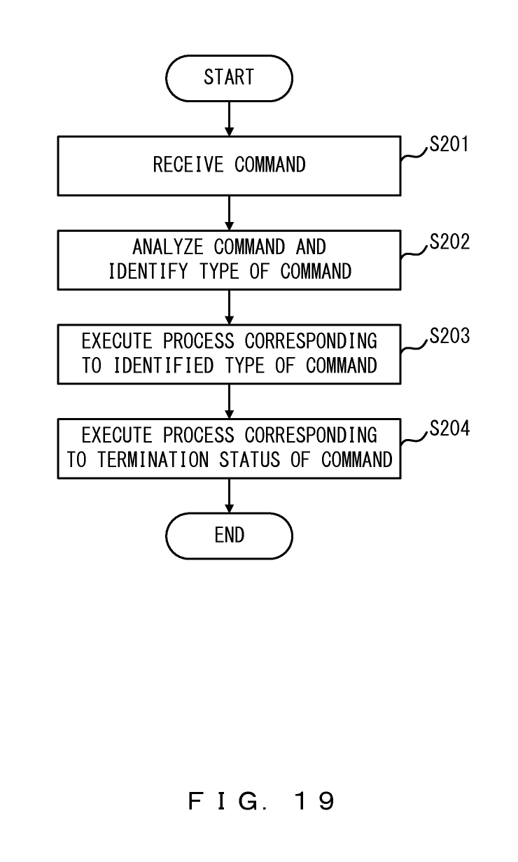

In FIG. 18, first, the control unit 23 performs a receiving process for a command from the host (S101). Details of the receiving process for a command are explained later using FIG. 19.

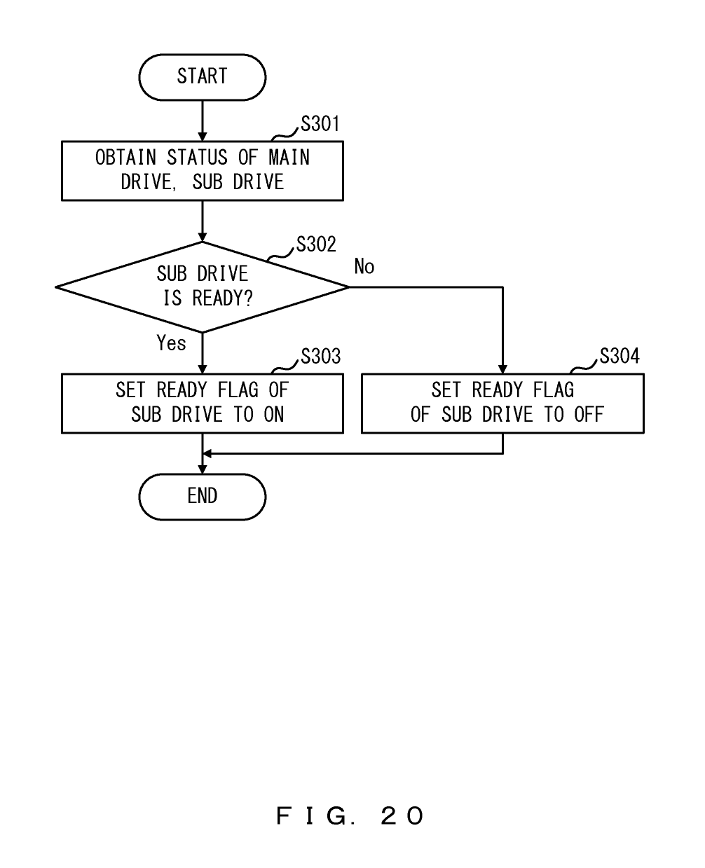

Next, the control unit 23 performs monitoring as to whether the status of each drive is ready or offline (S102). Details of the process of monitoring of the status of the drive are explained later using FIG. 20.

Next, the control unit 23 judges whether or not a ready flag of the sub drive 25 is on (S103). Here, the ready flag of the drive is a flag that indicates whether or not a cartridge is inserted (whether or not it is mounted) into the drive. When a cartridge is inserted into the drive, the value of the ready flag is “on”, and when it is not inserted, the value of the ready flag is “off”. The ready flag is stored in the storage unit 26. When it is judged that the ready flag of the sub drive 25 is off (S103, No), the process moves to S101.

When it is judged in S103 that the ready flag of the drive is on (S103, Yes), the control unit 23 judges whether a write flag of the main drive 24 is on (S104). Here, the write flag of the main drive 24 is a flag that indicates whether writing of data into the cartridge in the main drive 24 has occurred. When writing of data into the cartridge in the main drive 24 has occurred, the value of the write flag is “on”, and when writing of data into the cartridge in the main drive 24 has not occurred, the value of the write flag is “off”. The write flag is stored in the storage unit 26. When it is judged that the write flag of the main drive 24 is off (S104, No), the process moves to S101.

When it is judged in S104 that the write flag of the main drive 24 is on (S104, Yes), the control unit 23 judges whether or not an EOT flag of the sub drive 25 is on (S105). here, the EOT flag is a flag that indicates whether or not the head has reached the terminal end of the final lap as a result of writing of data into the sub cartridge. That is, when the EOT flag of the sub drive 25 is on, the tape in the sub drive 25 is in a state in which it is impossible to add data. The EOT flag is stored in the storage unit 26. When it is judged that the EOT flag of the sub drive 25 is on (S105, Yes), the process moves to S101.

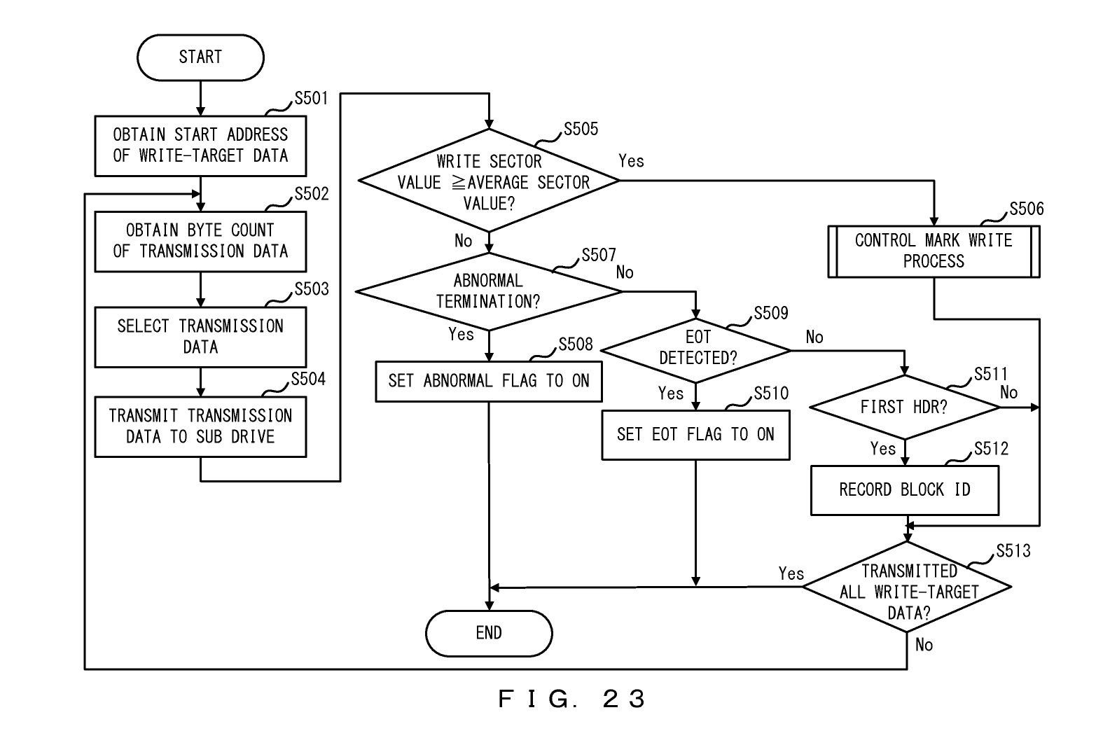

When it is judged in S105 that the EOT flag of the sub drive 25 is off (S105, No), the control unit 23 starts the file write process of the sub drive 25 (S106). The file write process of the sub drive 25 is explained later with reference to FIG. 23.

Next, details of the operation flow of the receiving process for a command from the host, which is the process in S101, are explained. FIG. 19 is a flowchart illustrating the operation flow of a host command receiving process.

In FIG. 19, the control unit 23 first receives a command from the host (S201).

Next, the control unit 23 analyzes the received command, to identify the type of the command (S202). Here, examples of the types of the command are given. Command types include, for example, a WT (Write) command, an RD (Read) command, an SP (Space Block) command, an SPF (Space File) command, and the like. In addition, command types include, for example, a BSP (Back Space Block) command, a BSPF (Back Space File) command, a FileSearch command, and the like.

The write command is a command to write data. The read command is a command to read data. The SP command is a command to move forward by one block. The SPF command is a command to move forward by one file that is between tape marks. The BSP command is a command to move backward by one block. The BSPF command is a command to move backward by one file that is between tape marks. The FileSearch command is a command to search for a file having the specified file name.

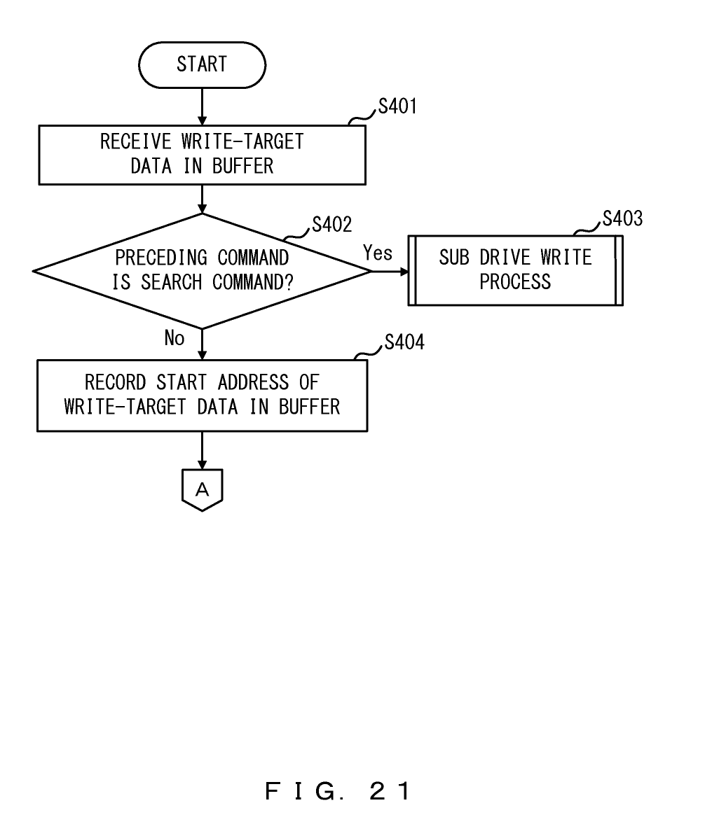

Then, the control unit 23 executes a process that corresponds to a specific command, according to the type of the received command (S203). The flow of the process corresponding to each command is explained later with reference to FIG. 21-FIG. 26.

When the process corresponding to the command has been completed, the control unit 23 checks the status of the process in S203 and executes a process corresponding to the status (S204). For example, the control unit 23 refers to the value of a normal flag and an abnormal flag stored in the storage unit 26 in judging whether or not the process in S203 was terminated in a normal manner. When the normal flag is on, the control unit 23 judges that the process was terminated in a normal manner, and when the abnormal flag is on, the control unit 23 judges that the process was terminated in an abnormal manner. Upon judging that the process in S203 was terminated in an abnormal manner, the control unit 23 may transmit a report of the occurrence of an abnormality to the host. Then, the process is terminated.

Next, details of the operation of the monitoring process by the control unit 23 as to whether the status of each drive is ready or offline are explained. FIG. 20 is a flowchart illustrating the operation of the monitoring process for the status of each drive.

In FIG. 20, the control unit 23 first obtains the status of the main drive 24 and the sub drive 25 (S301). That is, the control unit 23 obtains information that indicates whether or not a tape cartridge is inserted (mounted) into each of the main drive 24 and the sub drive 25, from each of the drives.

Then, the control unit 23 judges whether or not a tape cartridge is inserted (mounted) into each of the main drive 24 and the sub drive 25 according to the information obtained from each drive in S301 (S302). In the explanation below, the status in which a tape cartridge is inserted (mounted) into the drive may be referred to as the ready status, and the status in which a tape cartridge is not inserted (mounted) into the drive may be referred to as the offline status.

When it is judged that the sub drive 25 is in the ready status (S302, Yes), the control unit 23 sets the ready flag of the sub drive 25 to “on” (S303). Then, the process is terminated.

On the other hand, when it is judged in S302 that the sub drive 25 is not in the ready status (S302, No), the control unit 23 sets the ready flag of the sub drive 25 to “off” (S304). Then, the process is terminated.

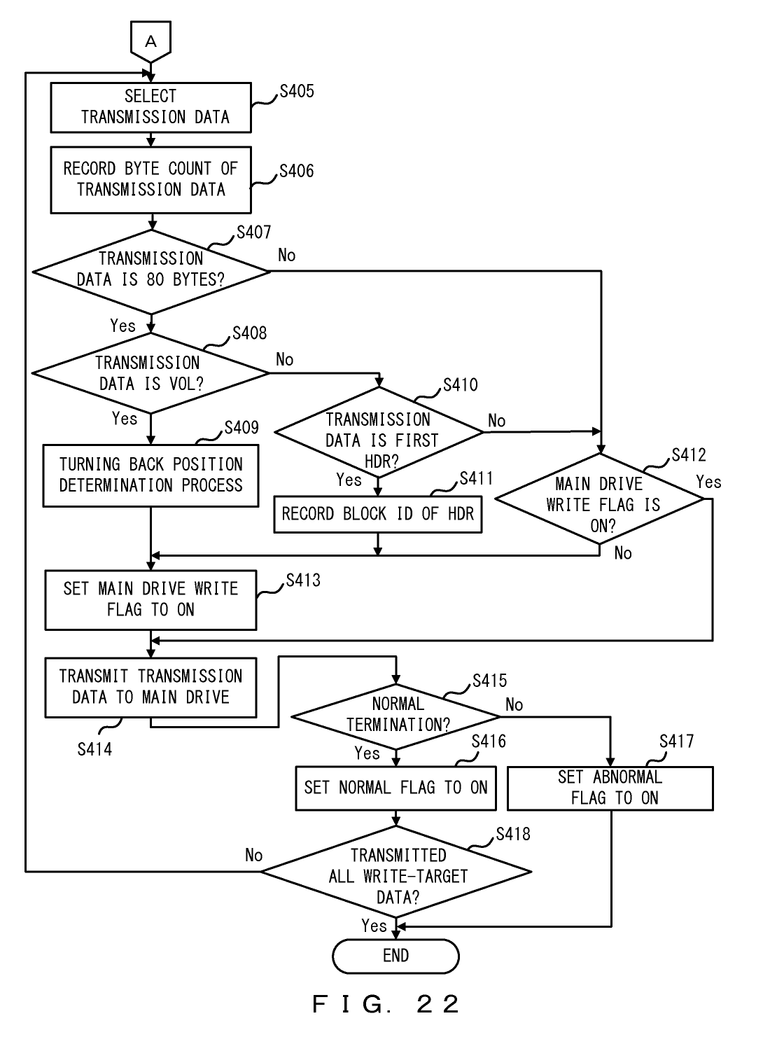

Next, the operation flow of the write process that writes a file into the main cartridge is explained with reference to FIG. 21 and FIG. 22. FIG. 21 is the first half of a flowchart illustrating the processing content of the write process that writes a file into the main cartridge. FIG. 22 is the second half of the flowchart illustrating the process content of the write process that writes a file into the main cartridge. In the flow in FIG. 21 and FIG. 22, the write-target data includes VOL, HDR, file data and EOF.

In FIG. 21, upon receiving a write command, the control unit 23 first stores write-target data received from the host together with the write command in a prescribed buffer in the tape apparatus (S401).

Next, the control unit 23 judges whether or not the command received from the host immediately before the write command received in S401 is a search command for the sub drive 25 (S402). Here, the search command is specifically an SP command, an SPF command, a BSP command, a BSPF command or a FileSearch command, for example.

When it is judged that the immediately preceding command is a search command (S402, Yes), the control unit 23 performs a data write process that writes data into the sub drive 25 (S403). Details of the data write process that writes into the sub drive 25 are explained later with reference to FIG. 23.

On the other hand, when it is judged in S402 that the immediately preceding command is not a search command (S402, No), the control unit 23 stores, in the storage unit 26, the start address of the area in which the write-target files are stored in the buffer (S404). Then, the process move to S405 in FIG. 22.

In S405 in FIG. 22, the control unit 23 selects data which is the transmission target to be transmitted to the drive (hereinafter, referred to as transmission data) among write-target data stored in the buffer (S405). The transmission data selected here is transmitted to the main drive 24, and then the transmission data is written into the main cartridge by the main drive 24.

Next, the control unit 23 stores a byte count of the transmission data in the storage unit 26 (S406). The byte count of the transmission data stored here is the accumulated value of the byte counts of data transmitted up to the present time among write-target data. Accordingly, the control unit 23 manages the progress of the completion of the writing in the write-target data.

Next, the control unit 23 judges whether or not the size of the transmission data is 80 bytes (S407). When it is judged that the size of the transmission data is not 80 bytes

(S407, No), the process moves to S412. On the other hand, when it is judged that the size of the transmission data is 80 bytes (S407, Yes), the control unit 23 judges whether or not the transmission data is a VOL label (S408).

In S408, when it is judged that the transmission data is a VOL label (S408, Yes), the control unit 23 calculates the average sector value for determining the turning-back position (S409).

In calculating the average sector value, specifically, the control unit 23 first judges whether or not a write process has been performed before for the volume indicated by the VOL label of the transmission data. When it is judged that a write process has been performed before for the volume indicated by the VOL label of the transmission data, the control unit 23 obtains the sector value of the previous writing. Then, the control unit 23 divides the obtained sector value by the total number of laps of the sub cartridge, and the value of the result of the division is obtained as the average sector value.

More specifically, the control unit 23 judges whether or not a record that has the same volume name 31 as the volume name indicated by the VOL label of the transmission data exists in volume information stored in the storage unit 26. Then, when it is judged that a record that has the same volume name 31 as the volume name indicated by the VOL label of the transmission data exists, the control unit 23 obtains the value of the volume sector value 32 corresponding to the volume name 31. Then, the control unit 23 calculates a value obtained by dividing the obtained volume sector value by the total number of laps of the sub cartridge as the average sector value.

On the other hand, when it is judged that the write process has not been performed before for the volume indicated by the VOL label of the transmission data, the control unit 23 calculates a value that is ½ of the sector value corresponding to the tape length from the starting end to the terminal end of the tape as the average sector value.

Then, the process moves to S413.

When it is judged in S408 that the transmission data is not a VOL label (S408, No), the control unit 23 judges whether or not the transmission data is the HDR label transmitted to the main drive 24 first among the write-target data (S410). When it is judged that the transmission data is the HDR label transmitted to the main drive 24 first among the write-target data (S410, Yes), the control unit 23 stores the block ID of the transmission data in the storage unit 26 (S411). That is, the block ID of the HDR label transmitted to the main drive 24 first among the write-target data is stored in the storage unit 26.

When it is judged in S410 that the transmission data is not the HDR label transmitted to the main drive 24 first among the write-target data (S410, No), the control unit 23 judges whether or not the value of the write flag of the main drive 24 is “on” (S412). When it is judged that the value of the write flag of the main drive 24 is not “on”, that is, it is “off”, (S412, No), the process moves to S413. When it is judged that value of the write flag of the main drive 24 is “on” (S412, Yes), the process moves to S414.

In S413, the control unit 23 sets the value of the write flag of the main drive 24 to “on” (S413). Next, the control unit 23 transmits the transmission data selected in S405 to the main drive 24 (S414). The data transmitted to the main drive 24 is written into the main cartridge by the main drive 24.

Next, the control unit 23 judges whether or not the writing of the data transmitted in S414 to the main drive 24 into the main cartridge was terminated in a normal manner (S415). Specifically, the control unit 23 judges whether or not the writing of the data transmitted to the main drive 24 into the main cartridge was terminated in a normal manner by receiving information from the main drive 24 that indicates whether or not the writing was terminated in a normal manner.

When it is judged in S415 that the writing into the main cartridge was not terminated in a normal manner (S415, No), the control unit 23 sets the value of the abnormal flag to “on” (S417). Then, the process is terminated.

On the other hand, when it is judged in S415 that the writing into the main cartridge was terminated in a normal manner (S415, Yes), the control unit 23 sets value of the normal flag to “on” (S416).

Next, the control unit 23 judges whether or not all the write-target data has been transmitted to the main drive (S418). When the control unit 23 judges that any of the write-target data has not been transmitted to the main drive yet (S418, No), the process moves to S405. On the other hand, when the control unit 23 judges that all the write-target data has been transmitted to the main drive (S418, Yes), the process is terminated.

Next, the operation flow of a file write process that writes into the sub cartridge is explained. FIG. 23 is a flowchart illustrating the processing content of a file write process that writes into the sub cartridge. The flow in FIG. 23 is explained assuming that it starts after the writing of the write-target files into the main cartridge explained in FIG. 21 and FIG. 22 is completed.

In FIG. 23, the control unit 23 first obtains the start address of the write-target files stored in the buffer recorded in the storage unit 26 in S404 (S501).

Next, the control unit 23 obtains the byte count of the transmission data to the main drive 24 recorded in the storage unit 26 in S406 (S502).

Next, the control unit 23 selects transmission data to transmit to the sub drive 25 among write-target data stored in the buffer (S503). The size of the transmission data selected here may be the byte count of the transmission data obtained in S502 so as to match it with that for the main drive 24.

Next, the control unit 23 transmits the transmission data selected in S503 to the sub drive 25 (S504). The transmission data transmitted to the sub drive 25 is written into the sub cartridge by the sub drive 25.

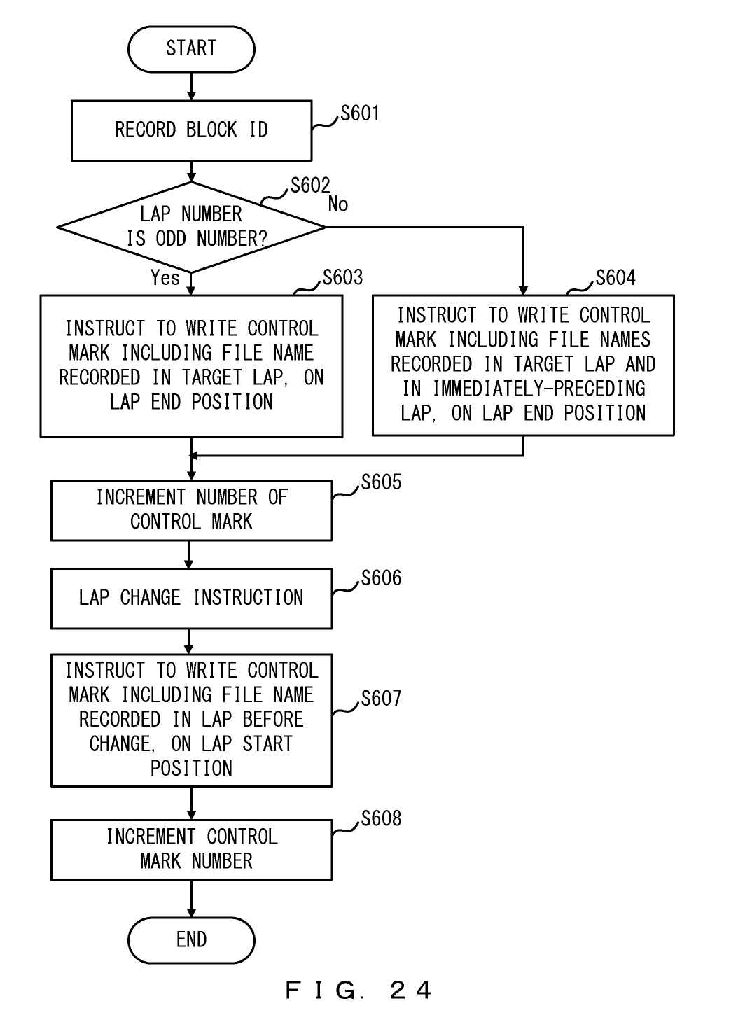

Next, the control unit 23 compares the write sector value which is the sector value of the data written into the write-target lap in the sub cartridge among the write-target data with the average sector value, and the control unit 23 judges whether or not the write sector value is equal to or greater than the average sector value (S505). The average sector value is the value calculated in S409 or S909. When it is judged that the write sector value is equal to or greater than the average sector value (S505, Yes), the control unit 23 judges that the position of the head at the time of the completion of the writing of the transmission data transmitted in S504 is the turning-back position, and the control unit 23 performs a write process that writes the control mark (S506). When the write-target lap is the final lap in S505, it is impossible to perform a further turning-back process, and therefore, the process moves to S507. The write process for the control mark is explained later with reference to FIG. 24. Then, the process moves to S513.

When it is judged in S505 that the write sector value is smaller than the average sector value (S505, No), the control unit 23 judges whether or not the writing of the transmission data transmitted in S504 to the sub drive 25 into the sub cartridge was terminated in a normal manner (S507).

Specifically, the control unit 23 judges whether or not the writing of the transmission data transmitted to the sub drive 25 into the sub cartridge was terminated in a normal manner by receiving information from the sub drive 25 that indicates whether the writing was terminated in a normal manner.

When it is judged in S507 that the writing into the sub cartridge was terminated in an abnormal manner (S507, Yes), the control unit 23 sets the value of the abnormal flag to “on” (S508). Then, the process is terminated.

When it is judged in S507 that the writing into the sub cartridge was terminated in a normal manner (S507, No), the control unit 23 judges whether or not the EOT of the sub cartridge was detected (S509). Specifically, for example, the control unit 23 receives from the sub drive 25 a report that indicates that the terminal end (EOT) of the final lap was detected during the writing of the transmission data transmitted in S504, and the control unit 23 judges that the EOT of the sub cartridge was detected, by checking the reception of the report.

When it is judged in S509 that the EOT was detected (S509, Yes), the control unit 23 sets the EOT flag to “on” (S510).

Then, the process is terminated.

When it is judged in S509 that the EOT was not detected (S509, No), the control unit 23 judges whether or not the transmission data transmitted in S504 is the HDR label that was transmitted to the sub drive 25 first among the write-target data (S511) . When it is judged that the transmission data is the HDR label that was transmitted to the sub drive 25 first among the write-target data (S511, Yes), the control unit 23 stores the block ID of the transmission data in the storage unit 26. Then, the process moves to S513.

When it is judged in S511 that the transmission data is not the HDR label that was transmitted to the sub drive 25 first among the write-target data (S511, No), the process moves to S513.

In S513, the control unit 23 judges whether or not the transmission of all the data in the transmission-target data has been completed (S513). When it is judged that the transmission of all the data in the transmission-target data has been completed (S513, Yes), the process is terminated. When it is judged that the transmission of all the data in the transmission-target data has not been completed (S513, No), the process moves to S502.

Next, the operation of the control mark write process, which is the process in S505, is explained. FIG. 24 is a flowchart illustrating the operation flow of the control mark write process.

In FIG. 24, the control unit 23 first stores, in the storage unit 26, the block ID of the block that was written into the sub cartridge immediately before the control mark write process was performed (S601).

Next, the control unit 23 judges whether or not the lap number of the lap in which data writing is currently being performed (this lap is referred to as the target lap) is an odd number (S602). Here, a lap whose lap number is an odd number is a lap into which data is written in forward order, and a lap whose lap number is an even number is a lap into which data is written in backward order. When it is judged that the lap number of the target lap is an odd number (S602, Yes), the control unit 23 makes the control mark include information of the file name of the file recorded in the target lap. Then, the control unit 23 instructs the sub drive 25 to write the control mark at the end position of the target lap immediately after the block that was written into the sub cartridge immediately before. Then, the process moves to S605.

When it is judged in S602 that the lap number of the target lap is an even number (S602, No), the control unit 23 records the file names of the files stored in the target lap and in the lap immediately before a change of the target lap in the control mark. The control unit 23 instructs the sub drive 25 to write the control mark at the position immediately after the block that was written into the sub cartridge immediately before (S604). Then, the process moves to S605.

In S605, the control unit 23 increments the control mark number (S605). The control mark number is identification information for uniquely identifying each control mark in a plurality of control marks recorded in the sub cartridge.

Next, the control unit 23 instructs the sub drive 25 to perform a change of the lap (S606). Upon receiving the change instruction, the sub drive 25 performs a change to the next lap.

Next, the control unit 23 issues an instruction for writing a control mark including the file name of the file recorded in the lap before the change at the start position of the lap changed to in S606 (S607).

The control unit 23 increments the control mark number (S608). Then, the process is terminated.

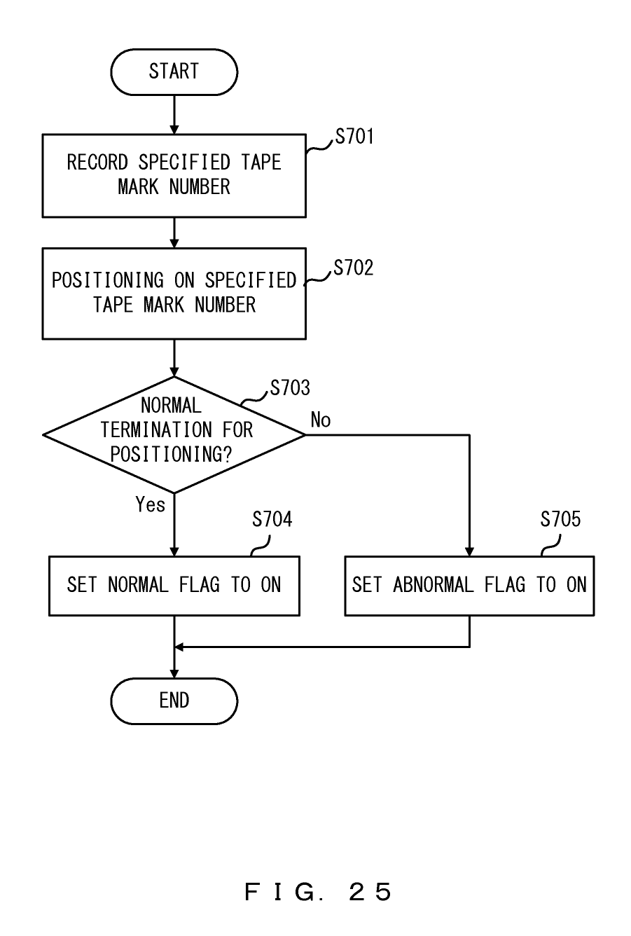

Next, the operation flow of a search for a file with a tape mark number being specified is explained. FIG. 25 is a flowchart illustrating the operation flow of a search for a file in the sub drive 25 with a tape mark number being specified.

In FIG. 25, first, the control unit 23 stores the tape mark number specified by the host in the storage unit 26 (S701).

Next, the control unit 23 instructs the sub drive 25 to position the head at the specified tape mark number (S702). Then, the control unit 23 judges whether or not the positioning at the specified tape number was terminated in a normal manner (S703). That is, the control unit 23 receives a report that indicates whether or not the positioning of the drive at the specified tape mark number was terminated in a normal manner, and the control unit 23 judges whether or not the positioning at the specified tape number was terminated in a normal manner, according to the received report.

When it is judged in S703 that the positioning at the specified tape number was terminated in a normal manner (S703, Yes), the control unit 23 sets the value of the normal flag to “on” (S704). Then, the process is terminated.

On the other hand, when it is judged in S703 that the positioning at the specified tape number was not terminated in a normal manner (S703, No), the control unit 23 sets the value of the abnormal flag to “on” (S705). Then, the process is terminated.

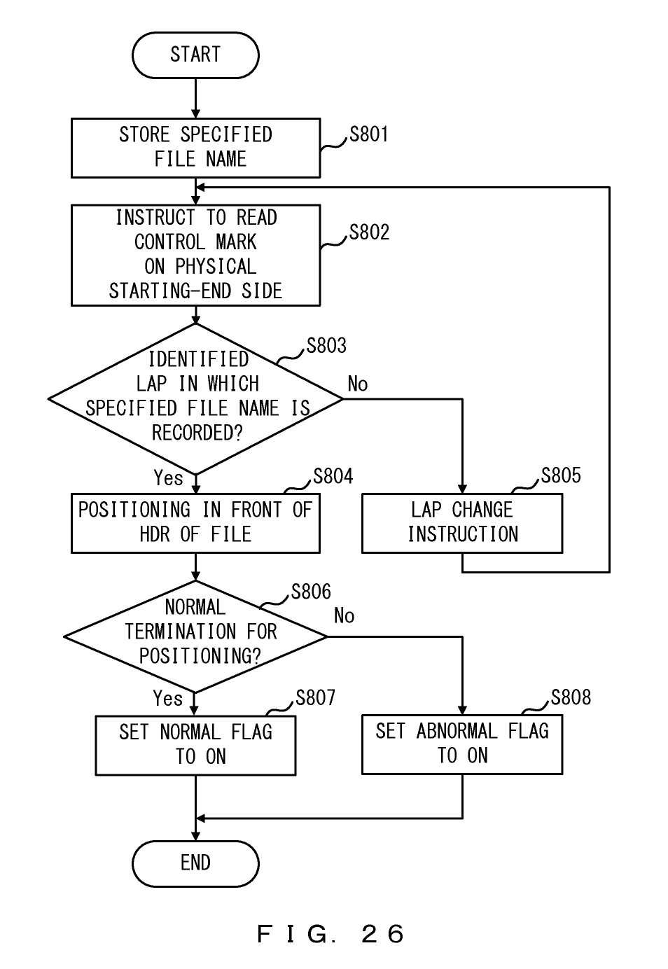

Next, the operation flow of a search for a file with the file name being specified is explained. FIG. 26 is a flowchart illustrating the operation flow of a search for a file in the sub drive 25 with the file name being specified.

In FIG. 26, the control unit 23 first stores a file name specified by the host in the storage unit 26 (S801).

Next, the control unit 23 instructs the sub drive to read the control mark on the starting-end side of the tape written in the lap of the sub cartridge (S802). Upon receiving the instruction to read the control mark on the starting-end side of the tape of the sub cartridge, the sub drive performs reading of the control mark on the starting-end side of the tape, and the sub drive transmits the content of the read control mark to the control unit 23. Upon receiving the content of the control mark as a response to the instruction for reading the control mark, the control unit 23 identifies the lap in which the specified file is recorded, according to the file name recorded in the control mark (S803).

When it is impossible in S803 to identify the lap in which the specified file is recorded (S803, No), the control unit 23 instructs the sub drive 25 to perform a change of the lap (S805). Then, the process returns to S802.

On the other hand, when the lap in which the specified file is recorded is identified in S803 (S803, Yes), the control unit 23 instructs the sub drive 25 to make the identified lap run and to position the head at the front position of the HDR of the specified file (S804).

Next, the control unit 23 judges whether or not the positioning at the front position of the HDR of the specified file was terminated in a normal manner (S806). That is, the control unit 23 receives from the sub drive 25 a report that indicates whether the positioning of the head of the drive at the position of the front position of the HDR of the specified file was terminated in a normal manner, and the control unit 23 judges whether or not the positioning on the specified tape number was terminated in a normal manner, according to the received report.

When it is judged in S806 that the positioning on the specified tape number was terminated in a normal manner (S806, Yes), the control unit 23 sets the value of the normal flag to “on” (S807). Then, the process is terminated.

On the other hand, when it is judged in S806 that the positioning at the specified tape number was not terminated in a normal manner (S806, No), the control unit 23 sets the value of the abnormal flag to on (S808). Then, the process is terminated.

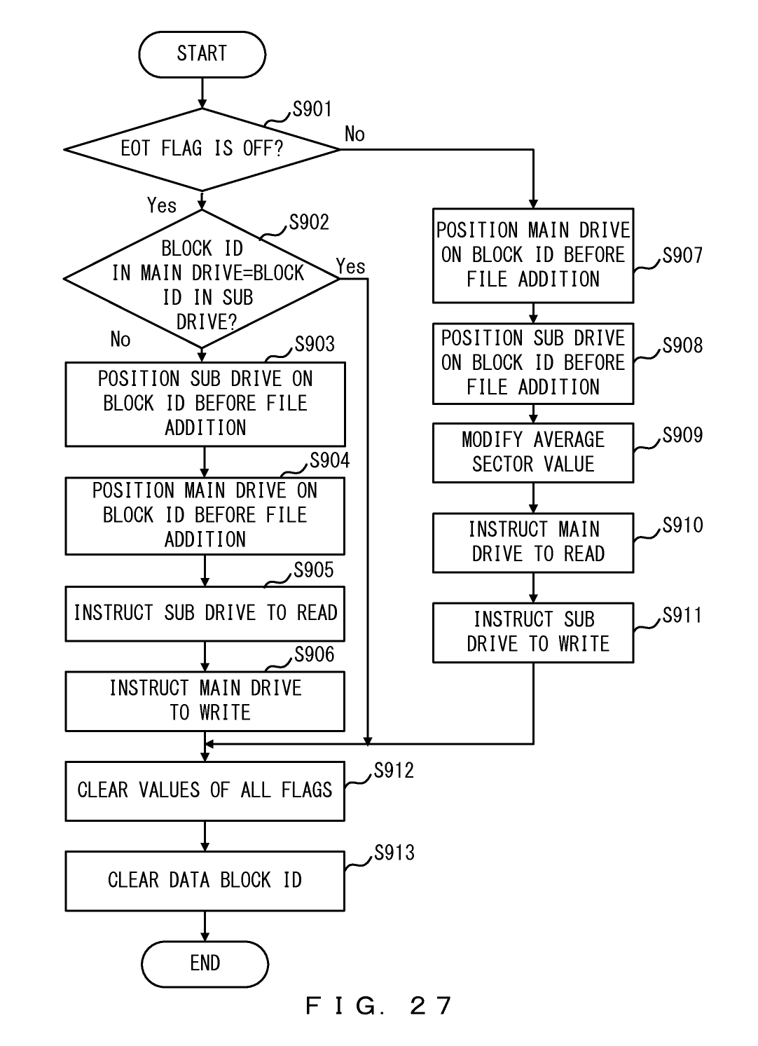

Next, the operation flow of a tape cartridge ejection process is explained. FIG. 27 is a flowchart illustrating the operation flow at the time of the tape cartridge ejection process.

In FIG. 27, the control unit 23 first judges whether or not the EOT flag of the sub drive 25 is off (S901). When it is judged that the EOT flag is off (S901, Yes), the control unit 23 judges whether or not the block ID for which the main drive 24 performed the latest writing is equal to the block ID for which the sub drive 25 performed the latest writing (S902).

When it is judged that the block ID for which the main drive 24 performed the latest writing is equal to the block ID for which the sub drive 25 performed the latest writing (S902, Yes), the process moves to S912.

When it is judged in S902 that the block ID for which the main drive 24 performed the latest writing and the block ID for which the sub drive 25 performed the latest writing are different (S902, No), the control unit 23 performs the following process. That is, the control unit 23 instructs the sub drive 25 to position the head of the drive at the position of the block ID before addition of the write-target data (S903). Specifically, the control unit 23 controls the sub drive 25 so as to position the head at the position in the sub cartridge at which the block of the block ID recorded in the storage unit 26 in S512 is stored.

Then, the control unit 23 instructs the main drive 24 to position the head of the drive at the position of the block ID before addition of the write-target data (S904). Specifically, the control unit 23 controls the main drive 24 so as to position the head at the position in the main cartridge at which the block corresponding to the block ID recorded in the storage unit 26 in S512 is stored.

Next, the control unit 23 instructs the sub drive 25 to read data in the sub cartridge from the position at which the head was positioned in S903 (S905). Upon receiving the read instruction, the sub drive 25 stores the read data in the buffer in the tape apparatus. Then, the control unit 23 instructs the main drive 24 to write the data that was read in S905 into the main cartridge (S906). Then, the process moves to S912.

When it is judged in S901 that the EOT flag is on (S901, No), the control unit 23 instructs the main drive 24 to position the head of the drive at the position of the block of the block ID before addition of the write-target data (S907), Specifically, the control unit controls the main drive 24 so as to position the head at the position in the main cartridge at which the block of the block ID stored in the storage unit 26 in S411 is written.

Then, the control unit 23 instructs the sub drive 25 to position the head of the drive at the position of the block

ID before addition of the write-target data (S908). Specifically, the control unit 23 controls the sub drive 25 so as to position the head at the position in the sub cartridge at which the block corresponding to the block ID recorded in the storage unit 26 in S411 is recorded.

Next, the control unit 23 calculates the average sector value according to the sum of the write sector values at the time when all the blocks of the write-target file are written into the main drive 24 (S909). Specifically, for example, the control unit 23 calculates the value by dividing the sector value of the write-target files written into the main cartridge by the number of laps from the lap from which re-writing is performed to the final lap.

Next, the control unit 23 instructs the main drive 24 to read data in the main cartridge from the position specified in S907 (S910). Upon receiving the read instruction, the main drive 24 stores the read data in the buffer in the tape apparatus. Then, the control unit 23 instructs the sub drive 25 to write the data read in S910 into the sub cartridge (S911). The write process that writes into the sub cartridge is the same as that explained in FIG. 23. Then, the process moves to S912.

In S912, the control unit 23 clears the value of all the flags stored in the storage unit 26 (S912). That is, the control unit 23 clears the values of the ready flag, the write flag, the EOT flag, the normal flag, and the abnormal flag. Then, the control unit 23 clears the data block IDs for the main drive 24 and the sub drive 25 stored in the storage unit 26 (S913). Then, the process is terminated.

Meanwhile, in S907, the position of the main drive 24 specified by the control unit 23 may be the position in the main cartridge at which the block of the block ID stored in the storage unit 26 in S601 is stored. In that case, in S908, the position of the sub drive 25 specified by the control unit 23 may be the position in the sub cartridge at which the block of the block ID stored in the storage unit 26 in S601 is stored.

In addition, in a case in which the control unit 23 instructs the main drive 24 to position the head of the drive at the position of the block of the block ID before addition of the write-target data in S907, S601 may be omitted.

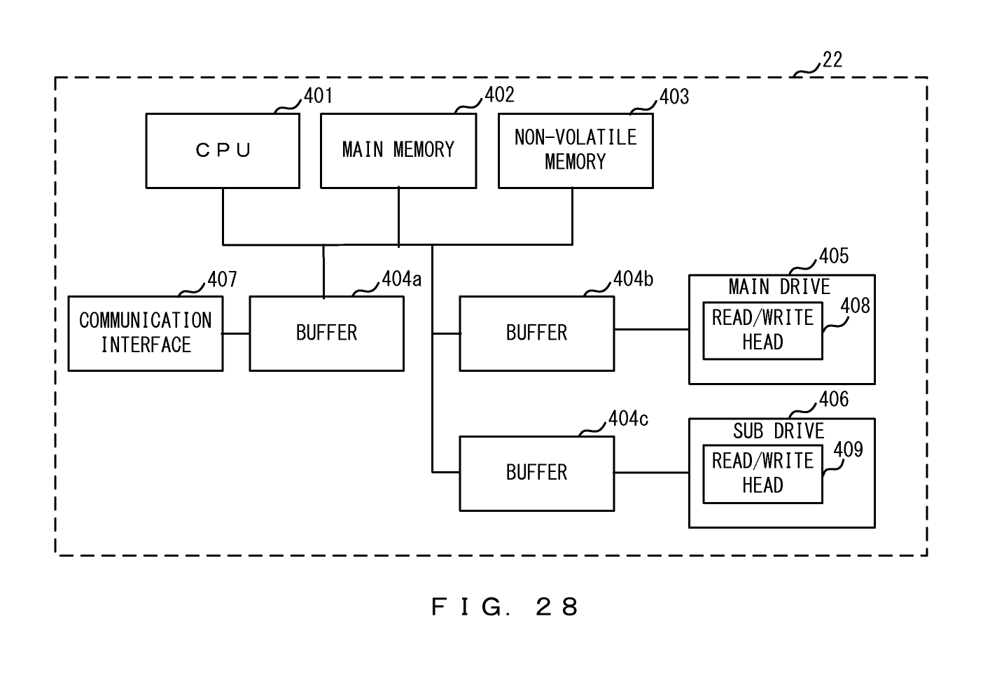

Next, the configuration of the tape apparatus according to the present embodiment is explained. FIG. 28 illustrates an example of the hardware configuration of the tape apparatus 22.

The tape apparatus 22 includes a CPU (Central Processing Unit) 401, a main memory 402, a non-volatile memory 403, buffers 404 (404a, 404b, 404c), a main drive 405, a sub drive 406 and a communication interface 407. The CPU 401, the memory 402, the non-volatile memory 403, and the buffers 404 (404a, 404b, 404c) are connected via a bus. The communication interface 407 and the buffer 404a, the main drive 24 and the buffer 404b, the sub drive 25 and the buffer 404c are respectively connected via a bus.

The CPU 401 provides some or all of the functions of the control unit 23 by executing a program that describes the procedures of the flowcharts described above, using the main memory 402.

The main memory 402 is a semiconductor memory for example, and it includes a RAM (Random Access Memory) area and a ROM (Read Only Memory) area.

The non-volatile memory 403 is a ROM or a flash memory, for example. In addition, the non-volatile memory 403 may also be a storage apparatus such as a hard disk. The non-volatile memory 403 provides a part or the entirety of the functions of the storage unit 26.

The buffer 404a temporarily stores data transmitted and received to and from the host via the communication interface 407.

The buffer 404b temporarily stores data read from the tape cartridge and data to be written into the tape cartridge by the main drive 24.

The buffer 404c temporarily stores data read from the tape cartridge and data to be written into the tape cartridge by the sub drive 25.

The main drive 405 includes a read/write head 408. The main drive 405 is an example of the main drive 24. The read/write head 408 is a head that performs reading and writing from and into the tape medium of the tape cartridge set in the main drive 405. The read/write head 408 is an example of the second write unit 13.

The sub drive 406 includes a read/write head 409. The sub drive 406 is an example of the sub drive 25. The read/write head 409 is a head that performs reading and writing from and into the tape medium of the tape cartridge set in the sub drive 406. The read/write head 409 is an example of the first write unit 11 and the read unit 14.

The communication interface 407 connects to the host and, and the communication interface 407 transmits and receives data to and from the host via a network, bus, or the like, according to an instruction from the CPU 401.

A program of the embodiment is provided to the tape apparatus 22 in the following forms, for example.
(1) Installed in advance in the non-volatile memory 403.
(2) Provided from a program server (not illustrated in the drawing) via the communication interface 407.

Furthermore, a part of the tape apparatus 22 of the embodiment may be realized with hardware. Alternatively, the tape apparatus 22 of the embodiment may be realized with a combination of software and hardware.

The present embodiment is not limited to the embodiment described above, and various configurations or embodiments may be adopted without departing from the spirit and scope of the invention.

The tape apparatus of the embodiment is capable of writing information in an optimal layout for reducing the access time to a file recorded in a tape cartridge. In addition, when reading data, the tape apparatus of the embodiment is capable of reducing the reading time for the data even when successive accesses occur for reading.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

1. A tape apparatus comprising:
a first write unit which writes information into one track of a plurality of tracks included in a first tape medium, and
a processor which executes a process including:
performing control to make the first drive unit write write-target information into a first track; and
performing control to make the first write unit write control information that indicates a terminal end of a track when a length from a position of the first write unit to a start position of the first track is equal to or greater than a prescribed threshold, and to move the first write unit to a second track.

2. The tape apparatus according to claim 1, the tape apparatus further comprising
a second write unit which writes the write-target information into a second tape medium including a plurality of tracks turned back at a starting end and at a terminal end of a tape, wherein
the process further including:
performing, when detecting a terminal end of a final track of the first tape medium during writing of the write-target information into the first tape medium, control to overwrite the first tape medium with information recorded in the second tape medium.

3. The tape apparatus according to claim 1, the process further including:
performing control to overwrite the second tape medium with information written into the first tape medium when writing of the write-target information into the first tape medium is completed.

4. The tape apparatus according to claim 1, wherein
the first write unit reads information written into one track of a plurality of tracks included in a tape medium, and
the process further including:
performing control to make the first write unit read information recorded in the first track, and when the control information is read, control to move the first write unit to the second track.

5. The tape apparatus according to claim 1, wherein
the control information includes information for identifying information recorded in each track.

6. The tape apparatus according to claim 1, wherein
the threshold is a value obtained by dividing a tape length in which the write-target information is stored by a number of tracks included in the first tape medium.

7. The tape apparatus according to claim 4, the process further including:
reading the control information recorded on a starting-end side of a tape among control information recorded in the track, and identifying information recorded in the track according to the read control information. 25

8. A write processing method to write information into a tape medium, the write processing method comprising:
writing, by a first write unit which writes information into one track of a plurality of tracks included in a first tape medium, write-target information into a first track; and
writing, by a first write unit control information that indicates a terminal end of a track when a length from a position of the first write unit to a start position of the first track is equal to or greater than a threshold, and moving to a second track.

9. A non-transitory computer-readable recording medium having stored therein a write control program for causing a computer to execute a process comprising:
making a first write unit which writes information into one track of a plurality of tracks included in a first tape medium write write-target information into a first track; and
making the first write unit write control information that indicates a terminal end of a track when a length from a position of the first write unit to a start position of the first track is equal to or greater than a threshold, and moving the first write unit to a second track.
